(19) United States
(12) Patent Application Publication
(10) Pub. No.: US 2025/0358769 A1
(43) Pub. Date: Nov. 20, 2025

(54) AI/ML POSITIONING TRAINING AND INFERENCE CONSISTENCY USING DATASET INDEXING

(71) Applicant: QUALCOMM Incorporated, San Diego, CA (US)

(72) Inventors: Mohammed Ali Mohammed HIRZALLAH, San Marcos, CA (US); Jay Kumar SUNDARARAJAN, San Diego, CA (US); Taesang YOO, San Diego, CA (US)

(21) Appl. No.: 18/663,855

(22) Filed: May 14, 2024

(51) Int. Cl. H04W 64/00; H04W 24/02

(52) U.S. Cl. CPC H04W 64/00; H04W 24/02

(57) ABSTRACT

Aspects presented herein may enable a consistency between multiple network entities in artificial intelligence (AI) or machine learning (ML) (AI/ML) related positioning training and inference. In one aspect, a first network entity transmits, to a second network entity, a request for an identifier (ID) to be used for indexing a set of datasets associated with at least one AI/ML model related to positioning. The first network entity receives, from the second network entity based on the request, the ID to be used for indexing the set of datasets associated with the at least one AI/ML model related to positioning. The first network entity stores, based on the ID, at least one of a set of positioning configurations or a set of radio statistics associated with the first network entity. The first network entity indexes the set of datasets with the ID.

### TECHNICAL FIELD

The present disclosure relates generally to communication systems, and more particularly, to wireless communication involving artificial intelligence (AI) or machine learning (ML) (AI/ML) positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a second network entity, a request for an identifier (ID) to be used for indexing a set of datasets associated with at least one artificial intelligence (AI) or machine learning (ML) (AI/ML) model related to positioning. The apparatus receives, from the second network entity based on the request, the ID to be used for indexing the set of datasets associated with the at least one AI/ML model related to positioning. The apparatus stores, based on the ID, at least one of a set of positioning configurations or a set of radio statistics associated with the first network entity. The apparatus indexes the set of datasets with the ID.

In an aspect of the disclosure, a method, a computer-readable medium, and an apparatus are provided. The apparatus receives, from a first network entity, a request for an ID to be used for indexing a set of datasets associated with at least one AI/ML model related to positioning. The apparatus transmits, to the first network entity based on the request, the ID to be used for indexing the set of datasets associated with the at least one AI/ML model related to positioning. The apparatus stores at least one of a set of positioning configurations or a set of radio statistics associated with the second network entity based on the transmission of the ID.

In an aspect of the disclosure, a method, a computer-readable medium, and an apparatus are provided. The apparatus indexes, with an ID, a set of datasets associated with at least one AI/ML model related to positioning. The apparatus stores, based on the ID, at least one of a first set of positioning configurations or a first set of radio statistics associated with a second network entity. The apparatus transmits, to a second network entity, the ID and an indication to log at least one of a second set of positioning configurations or a second set of radio statistics associated with the second network entity based on the ID.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of direct artificial intelligence (AI)/machine learning (ML) (AI/ML) positioning in accordance with various aspects of the present disclosure.

FIG. 5B is a diagram illustrating an example of AI/ML assisted positioning in accordance with various aspects of the present disclosure.

FIG. 6 is a diagram illustrating an example of different configurations for AI/ML assisted positioning in accordance with various aspects of the present disclosure.

FIG. 7 is a diagram illustrating an example of UE-based positioning with UE-side AI/ML model, direct AI/ML or AI/ML assisted positioning in accordance with various aspects of the present disclosure.

FIG. 8A is a diagram illustrating an example of UE-assisted/location management function (LMF)-based positioning with UE-side AI/ML model, AI/ML assisted positioning in accordance with various aspects of the present disclosure.

FIG. 8B is a diagram illustrating an example of UE-assisted/LMF-based positioning with LMF-side model, direct AI/ML positioning in accordance with various aspects of the present disclosure.

FIG. 9A is a diagram illustrating an example of network node assisted positioning with gNB-side model, AI/ML assisted positioning in accordance with various aspects of the present disclosure.

FIG. 9B is a diagram illustrating an example of network node assisted positioning with LMF-side model, direct AI/ML positioning in accordance with various aspects of the present disclosure.

FIG. 10 is a communication flow illustrating an example procedure of a UE-initiated dataset indexing in accordance with various aspects of the present disclosure.

FIG. 11 is a diagram illustrating an example of dataset indexing/marking over time in accordance with various aspects of the present disclosure.

FIG. 12 is a communication flow illustrating an example procedure of a location server-initiated dataset indexing in accordance with various aspects of the present disclosure.

FIG. 13 is a communication flow illustrating an example procedure of a base station-initiated dataset indexing in accordance with various aspects of the present disclosure.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

FIG. 18 is a flowchart of a method of wireless communication.

FIG. 19 is a flowchart of a method of wireless communication.

FIG. 20 is a diagram illustrating an example of a hardware implementation for an example network entity.

FIG. 21 is a flowchart of a method of wireless communication.

FIG. 22 is a diagram illustrating an example of a hardware implementation for an example network entity.

### DETAILED DESCRIPTION

Various aspects relate generally to wireless communication and more particularly to positioning based on wireless communication. Some aspects more specifically relate to enabling one or more network entities (e.g., a UE, a base station, and/or a location server) to train one or more AI/ML models for different/possible positioning configurations and radio characteristics/statistics. In some examples, a network entity/node may be configured with the capability to match a suitable/right AI/ML model for a set of configurations (which the network entity/node may not know) and radio characteristics/statistics based on a dataset identifier assigned by a location server. For example, based on an initiation from a network entity/node, a set of corresponding positioning configurations may be logged and be associated with respective dataset identifiers by multiple network entities/nodes. The measurements associated with these positioning configurations may be used to train one or more AI/ML positioning models. During an operation, a network entity/node may determine a dataset identifier to be used based on the current positioning configuration, communicate to another network entity/node the dataset identifier to be used and determine the AI/ML model to be used based on the data identifier. In another example, a location server may be configured to identify the dataset identifier to be used, and communicate it to a UE and a base station to enable them to pick a suitable/correct AI/ML model.

Particular aspects of the subject matter described in this disclosure can be implemented to realize one or more of the following potential advantages. Proprietary configuration changes on the base station-side may not be exposed to a UE and vice versa. There may also be radio characteristics/statistics changes to the underlying wireless channels. AI/ML models may specify to be trained for possible configurations and radio characteristics/statistics, additionally a UE/base station may be specified to match the suitable/right AI/ML model for a set of configurations (which the UE/base station may not know) and radio characteristics/statistics. As such, by enabling a UE, a base station, and/or a location server to initiate a dataset identifier request/assignment, sets of corresponding UE/base station/location server positioning configurations may be logged and be associated with respective dataset identifiers. These measurements associated with the UE/base station/location server may then be used to train one or more AI/ML positioning models. This may improve the overall performance and efficiency for AI/ML model training at different network entities/nodes.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

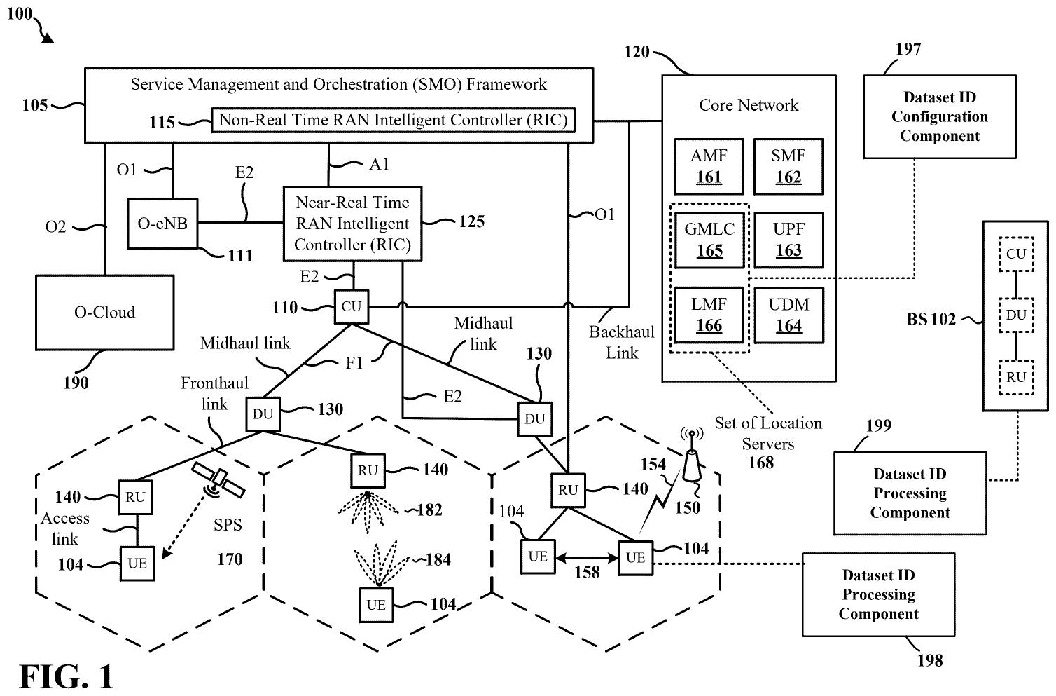

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a dataset ID processing component 198 that may be configured to transmit, to a second network entity, a request for an ID to be used for indexing a set of datasets associated with at least one AI/ML model related to positioning; receive, from the second network entity based on the request, the ID to be used for indexing the set of datasets associated with the at least one AI/ML model related to positioning; store, based on the ID, at least one of a set of positioning configurations or a set of radio statistics associated with the first network entity; and index the set of datasets with the ID. In certain aspects, the base station 102 may have a dataset ID processing component 199 that may be configured to transmit, to a second network entity, a request for an ID to be used for indexing a set of datasets associated with at least one AI/ML model related to positioning; receive, from the second network entity based on the request, the ID to be used for indexing the set of datasets associated with the at least one AI/ML model related to positioning; store, based on the ID, at least one of a set of positioning configurations or a set of radio statistics associated with the first network entity; and index the set of datasets with the ID. In certain aspects, the one or more location servers 168 may have a dataset ID configuration component 197 that may be configured to receive, from a first network entity, a request for an ID to be used for indexing a set of datasets associated with at least one AI/ML model related to positioning; transmit, to the first network entity based on the request, the ID to be used for indexing the set of datasets associated with the at least one AI/ML model related to positioning; and store at least one of a set of positioning configurations or a set of radio statistics associated with the second network entity based on the transmission of the ID. In certain aspects, the dataset ID configuration component 197 may also be configured to index, with an ID, a set of datasets associated with at least one AI/ML model related to positioning; store, based on the ID, at least one of a first set of positioning configurations or a first set of radio statistics associated with the first network entity; and transmit, to a second network entity, the ID and an indication to log at least one of a second set of positioning configurations or a second set of radio statistics associated with the second network entity based on the ID.

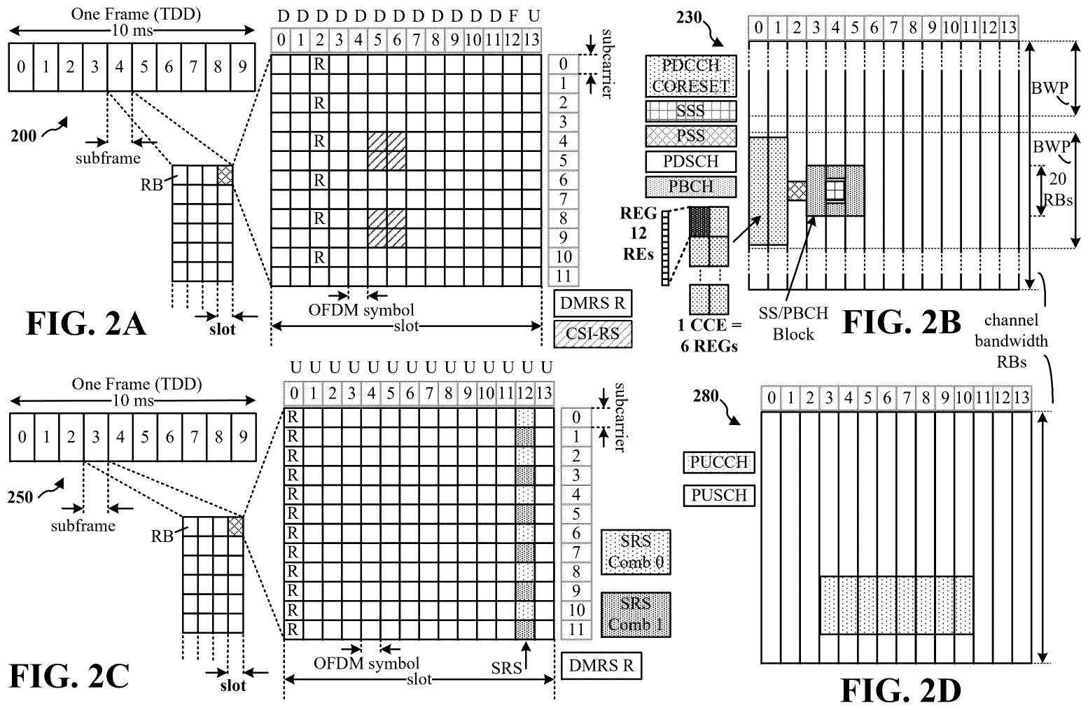

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

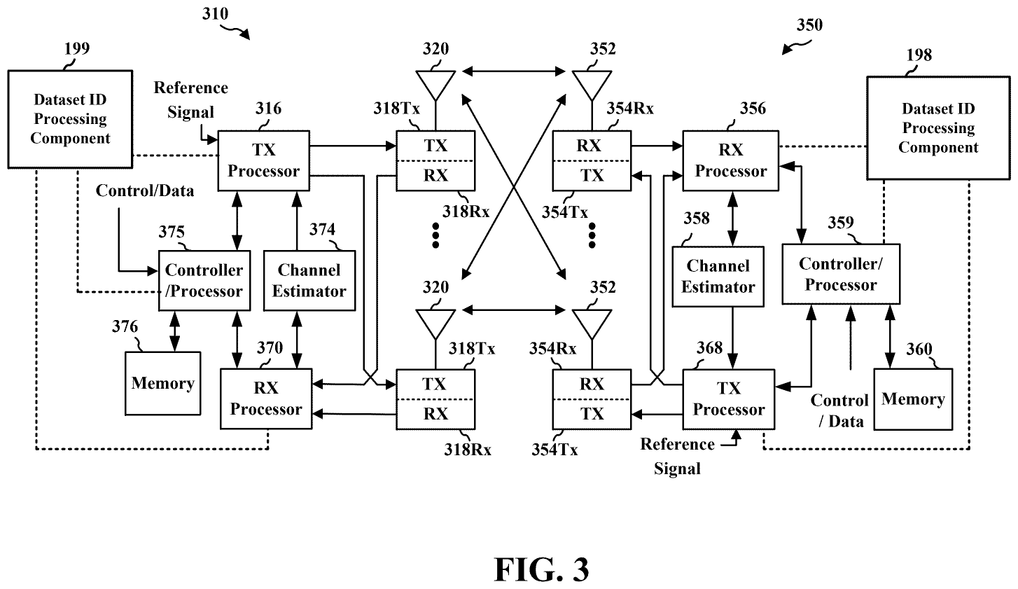

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the dataset ID processing component 198 of FIG. 1.

At least one of the TX processor 316, the RX processor 370, and the controller/processor 375 may be configured to perform aspects in connection with the dataset ID processing component 199 of FIG. 1.

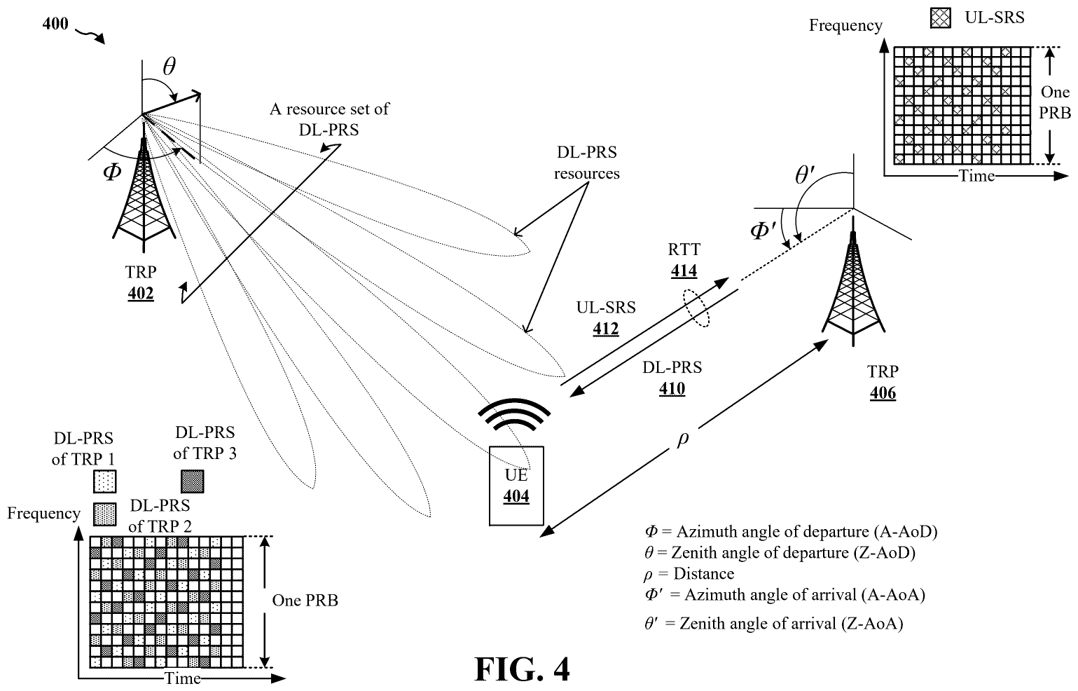

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In some implementations, at least one artificial intelligence (AI)/machine learning (ML) (AI/ML) model may be configured/implemented at a network entity/node (e.g., a UE, a base station, a location server, a location management function (LMF), etc.) for assisting the network entity/node with the positioning of a UE. For example, an AI/ML model may be trained to determine the position of a UE based on DL-AoA, DL-TDOA, channel impulse response (CIR), radio frequency (RF) fingerprinting, etc. In most scenarios, using an AI/ML model may significantly improve UE positioning latency, accuracy/reliability, and/or efficiency. For purposes of the present disclosure, an AI/ML model that is implemented at a UE side may be referred to as a “UE-side model” and/or “UE-side AI/ML model.” On the other hand, an AI/ML model that is implemented at a network side may be referred to as a “network-side model,” “network-side AI/ML model,” and/or (network name)-side AI/ML model (e.g., base station-side AI/ML model, LMF-side AI/ML model, etc.).

In addition, positioning that is associated with a UE or a network entity/node using an AI/ML model to determine the position of the UE may be referred to as “direct AI/ML positioning,” whereas positioning that is associated with a UE or a network entity/node performing positioning related measurements using an AI/ML model (and transmitting the positioning related measurements to another entity) to determine the position of the UE may be referred to as “AI/ML assisted positioning” and/or “assisted AI/ML positioning.” Also, UE-based positioning (e.g., UE determines its own position) using at least one UE-side AI/ML model may be referred to as “direct UE AI/ML positioning” and/or “UE direct AI/ML positioning,” whereas UE-assisted positioning (e.g., a UE provides positioning measurements and a network entity, such as an LMF, determines the position for the UE based on the positioning measurements provided by the UE) using at least one UE-side AI/ML model may be referred to as “UE AI/ML assisted positioning,” “UE assisted AI/ML positioning” “AI/ML assisted UE positioning,” and/or “AI/ML UE assisted positioning,” etc. Similarly, network-based positioning (e.g., a network entity, such as an LMF, determines the position for the UE) using at least one network/LMF-side AI/ML model may be referred to as “direct network/LMF AI/ML positioning” and/or “network/LMF direct AI/ML positioning.”

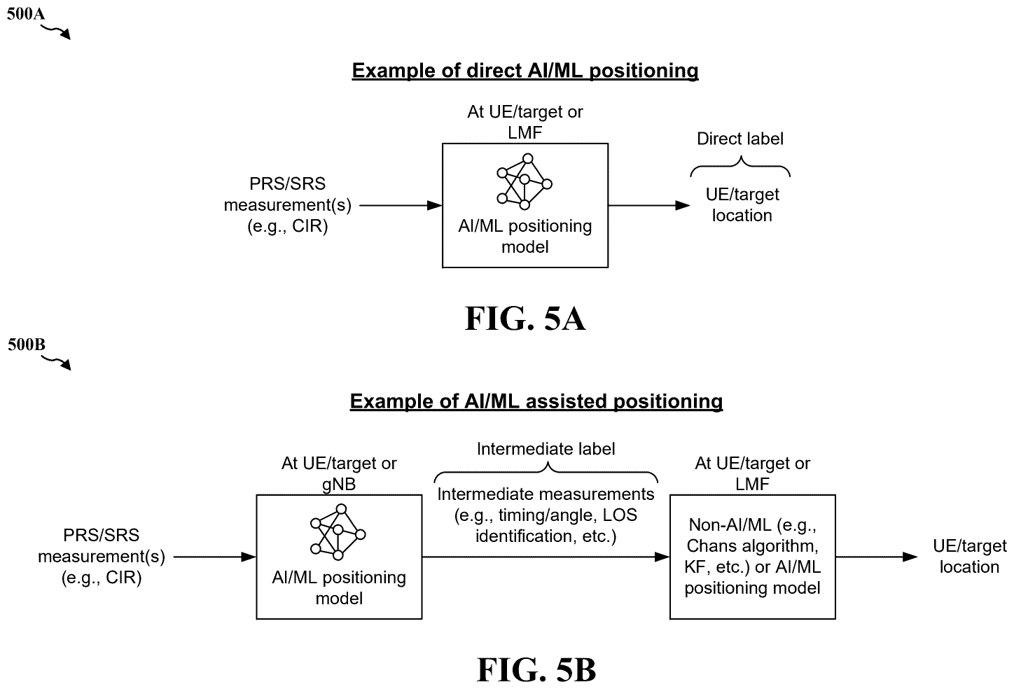

FIG. 5A is a diagram 500A illustrating an example of direct AI/ML positioning in accordance with various aspects of the present disclosure. For direct AI/ML positioning, a network entity (e.g., a UE, a base station, a location server, etc.) may use at least one AI/ML model to determine the position of a UE or a target. For example, a UE may receive and measure PRSs transmitted from one or more base stations, and the UE may determine its position using an AI/ML model based on the PRS measurements. In another example, an LMF may receive PRS measurements from a UE or SRS measurements from a base station, and the LMF may determine the position of the UE using an AI/ML model based on the PRS/SRS measurements.

FIG. 5B is a diagram 500B illustrating an example of AI/ML assisted positioning in accordance with various aspects of the present disclosure. For AI/ML assisted positioning, a network node/entity (e.g., a UE, a base station, etc.) may use at least one AI/ML model to assist the measurement of reference signals (e.g., positioning reference signals such as PRS, SRS, etc.). Then, the network node/entity may transmit the reference signal measurements to a location server, such as an LMF. In response, the location server may determine the position of the UE based on a non-AI/ML mechanism/algorithm, or based on using an AI/ML model to determine the position of the UE. For example, a UE may receive and measure PRSs transmitted from one or more base stations, and the UE may transmit the PRS measurements to an LMF. The PRS measurements may include intermediate measurements, such as timing and/or angle of the PRSs, whether the PRSs are received based on a line-of-sight (LOS) condition or a non-line-of-sight (NLOS) condition, etc. Then, the LMF may determine the position of the UE based on the PRS measurements (e.g., the intermediate measurements) with or without using an AI/ML model. Similarly, a base station may receive and measure SRSs transmitted from a UE, and the base station may transmit the SRS measurements to an LMF. Then, the LMF may determine the position of the UE based on the SRS measurements (e.g., the intermediate measurements) with or without using an AI/ML model.

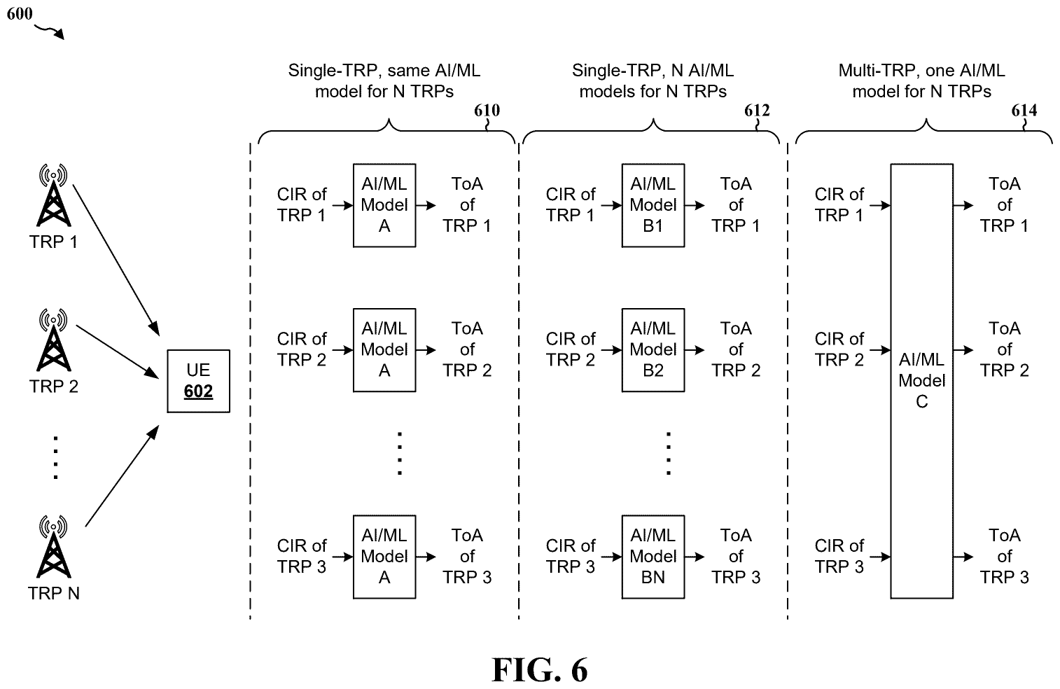

FIG. 6 is a diagram 600 illustrating an example of different configurations for AI/ML assisted positioning in accordance with various aspects of the present disclosure. In one example, as shown at 610, for AI/ML assisted positioning, a same AI/ML model may be used for multiple TRPs, where one AI/ML model may be configured for each TRP (referring to as the “single-TRP” setting). For example, a UE 602 may receive a set of positioning reference signals from N TRPs (e.g., from a first TRP, a second TRP, . . . , and up to an N^{th} TRP), and measure the channel impulse response (CIR), power delay profile (PDP), and/or delay profile (DP) for the set of positioning reference signals from each TRP. Then, the UE 602 may input the measured CIR, PDP, and/or DP for each TRP to an AI/ML model (e.g., AI/ML Model A) configured for/associated with each TRP, where the AI/ML model may infer the time of arrival (ToA), reference signal time difference (RSTD), time of flight (ToF), relative time of arrival (RTOA), TX-RX time difference, angle of departure (AoD), angle of arrival (AoA), and/or LOS indicator of the positioning reference signal for the corresponding TRP based on the corresponding CIR, PDP, and/or DP. In other words, CIR, PDP, and/or DP of the first TRP is input to an AI/ML model A associated with the first TRP, CIR, PDP, and/or DP of the second TRP is input to an AI/ML model A associated with the second TRP, and CIR, PDP, and/or DP of the N^{th} TRP is input to an AI/ML model A associated with the N^{th} TRP, etc. In another example, as shown at 612, different AI/ML models may be used for multiple TRPs, where one AI/ML model may be configured for each TRP (e.g., also the “single-TRP” setting but each TRP may use a different AI/ML model). For example, CIR, PDP, and/or DP of the first TRP may be input to a first AI/ML model (e.g., AI/ML Model B1) for inferring the ToA, the RSTD, the ToF, the RTOA, the TX-RX time difference, the AoD, the AoA, and/or the LOS indicator of the first TRP, CIR, PDP, and/or DP of the second TRP may be input to a second AI/ML model (e.g., AI/ML Model B2 that is different from AI/ML Model B1) for inferring the ToA, the RSTD, the ToF, the RTOA, the TX-RX time difference, the AoD, the AoA, and/or the LOS indicator of the second TRP, and CIR, PDP, and/or DP of the N^{th} TRP may be input to an N^{th} AI/ML model (e.g., AI/ML Model BN that is different from AI/ML Model B1 and AI/ML Model B2) for inferring the ToA of the AI/ML Model B1 TRP, etc. In another example, as shown at 614, one AI/ML model may be used for multiple TRPs (referring to as the “multi-TRP” setting). For example, CIRs, PDPs, and/or DPs from the N TRPs are input to one AI/ML model (e.g., AI/ML Model C), and the AI/ML model may infer the ToA, the RSTD, the ToF, the RTOA, the TX-RX time difference, the AoD, the AoA, and/or the LOS indicator for each TRP. For AI/ML assisted positioning, different model input realizations may have different implications on accuracy and generalization/robustness as well as model complexity and life cycle management (LCM).

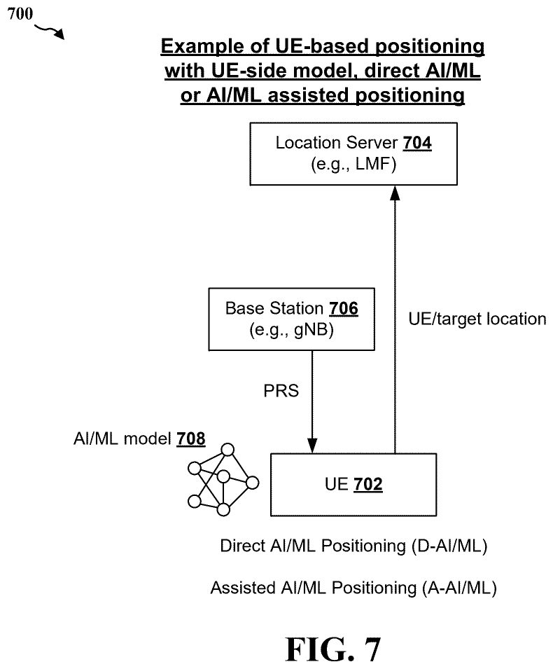

FIG. 7 is a diagram 700 illustrating an example of UE-based positioning with UE-side AI/ML model, direct AI/ML or AI/ML assisted positioning in accordance with various aspects of the present disclosure. In one implementation, a UE 702 may be associated with at least one AI/ML model 708, and the UE 702 may use the at least one AI/ML model 708 to perform the direct AI/ML positioning and/or the assisted AI/ML positioning based on downlink (DL) reference signals, such as positioning reference signals (PRSs). For example, the UE 702 may receive and measure a set of PRSs transmitted from a base station 706, such as measuring the reference signal received power (RSRP), channel impulse response (CIR), DL-AoD, reference signal time difference (RSTD), time of arrival (ToA), and/or time of flight (ToF) of the set of PRSs, etc., which may be collectively be referred to as “PRS measurement(s)” and/or “PRS-based measurement(s).” In some examples, the UE 702 may use the at least one AI/ML model 708 for measuring the set of PRSs (e.g., for assisted AI/ML positioning). In some examples, based on the PRS measurement(s), the UE 702 may use the at least one AI/ML model 708 for determining its position (e.g., for direct AI/ML positioning). Note in this assisted AI/ML positioning example, the UE 702 may use the at least one AI/ML model 708 for performing PRS measurements, and the UE 702 may determine its position based on the PRS measurements without the assistance of an AI/ML model.

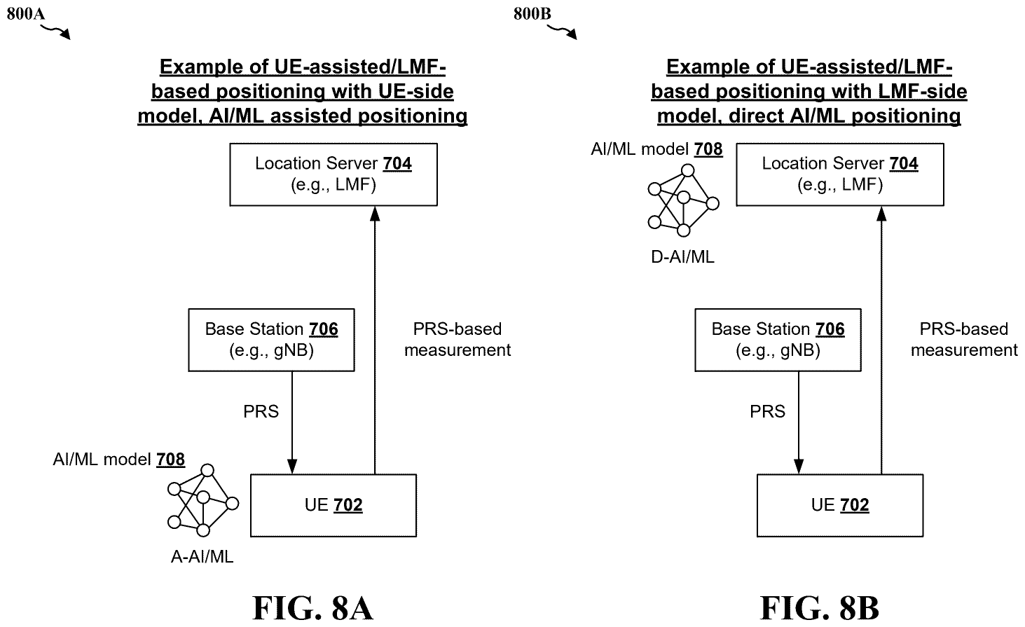

FIG. 8A is a diagram 800A illustrating an example of UE-assisted/LMF-based positioning with UE-side AI/ML model, AI/ML assisted positioning in accordance with various aspects of the present disclosure. In another implementation, a UE 702 may be associated with at least one AI/ML model 708, and the UE 702 may use the at least one AI/ML model 708 to perform or assist measurement(s) of DL reference signals. For example, the UE 702 may receive and measure a set of PRSs transmitted from a base station 706 with the assistance of the at least one AI/ML model 708, which may be referred to as “PRS-based measurement(s).” Then, the UE 702 may transmit the PRS-based measurement(s) to a location server 704, such as an LMF. In response, the location server 704 may determine the position of the UE 702 based on the PRS-based measurement(s) (with or without suing an AI/ML model).

FIG. 8B is a diagram 800B illustrating an example of UE-assisted/LMF-based positioning with LMF-side AI/ML model, direct AI/ML positioning in accordance with various aspects of the present disclosure. In another implementation, a UE 702 may not include a UE-side AI/ML model, and a location server 704 may use at least one AI/ML model 708 to determine the position of the UE 702. For example, the UE 702 may receive and measure a set of PRSs transmitted from a base station 706, and the UE 702 may transmit the PRS-based measurement(s) to the location server 704, such as an LMF. In response, the location server 704 may use the at least one AI/ML model 708 to determine the position of the UE 702 based on the PRS-based measurement(s) from the UE 702.

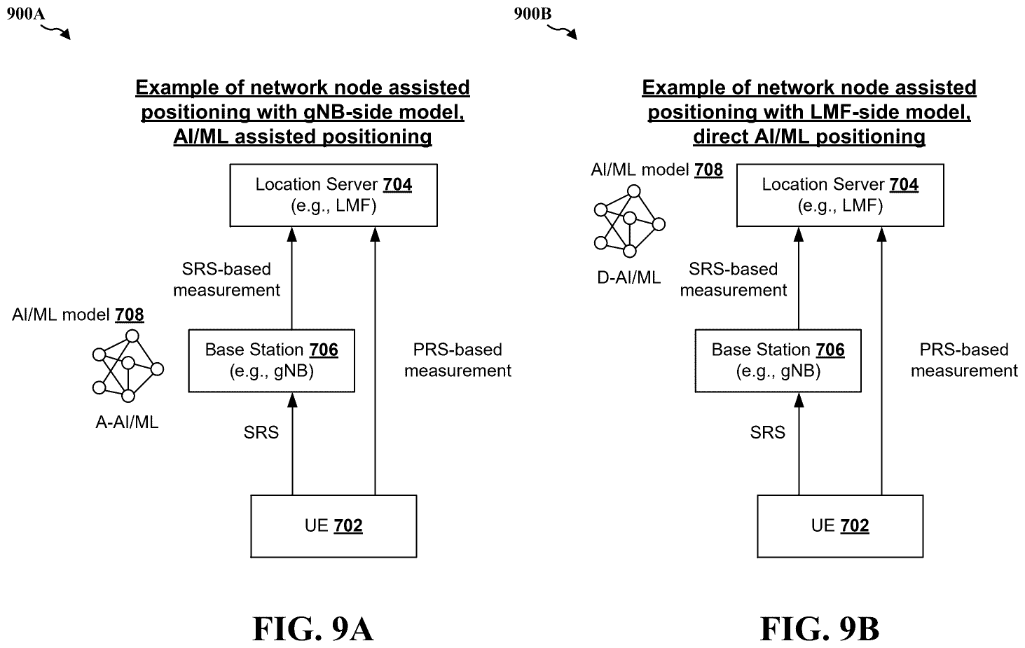

FIG. 9A is a diagram 900A illustrating an example of network (e.g., NG-RAN) node assisted positioning with gNB-side AI/ML model, AI/ML assisted positioning in accordance with various aspects of the present disclosure. In another implementation, a network node, such as a base station 706, may be associated with at least one AI/ML model 708, and the base station 706 may use the at least one AI/ML model 708 to assist measurement(s) of uplink (UL) reference signals, such as sounding reference signals (SRSs). For example, the UE 702 may transmit a set of SRSs to the base station 706, and the base station 706 may receive and measure the set of SRSs (which may be referred to as “SRS-based measurement(s)”) with the assistance of the at least one AI/ML model 708. Then, the base station 706 may transmit the SRS-based measurement(s) to the location server 704, such as an LMF. In response, the location server 704 may determine the position of the UE 702 based on the SRS-based measurement(s) from the base station 706 (with or without suing an AI/ML model). FIG. 9B is a diagram 900B illustrating an example of network (e.g., NG-RAN) node assisted positioning with LMF-side AI/ML model, direct AI/ML positioning in accordance with various aspects of the present disclosure. In another implementation, a network node, such as a base station 706, may not include an AI/ML model, and a location server 704 may use at least one AI/ML model 708 to determine the position of a UE 702. For example, the UE 702 may transmit a set of SRSs to the base station 706, and the base station 706 may receive and measure the set of SRSs. Then, the base station 706 may transmit the SRS-based measurement(s) to the location server 704, such as an LMF. Based on the SRS-based measurement(s) from the base station 706, the location server 704 may use the at least one AI/ML model 708 to determine the position of the UE 702. For purposes of the present disclosure, positioning described in connection with FIGS. 7, 8A, and 8B may be referred to as AI/ML positioning based on DL reference signals, and positioning described in connection with FIGS. 9A and 9B may be referred to as AI/ML positioning based on UL reference signals.

In some scenarios, training AI/ML models may specify managing datasets (e.g., information and measurements that are used as inputs and training data for the AI/ML models), where an identified positioning AI/ML model may be configured to be linked to a set of datasets used for training the positioning AI/ML model. For example, a model identification associated with dataset collection related configuration(s) and/or indication(s) and/or dataset transfer may be specified for the positioning AI/ML model training. In some implementations, for inference for UE-side AI/ML models, to ensure consistency between training and inference regarding network-side conditions (e.g., network-side conditions may include positioning configurations), model identification may be defined to achieve alignment on the network (NW)-side condition (which may also refer to NW condition) and/or NW additional conditions between network-side and UE-side. In some examples, NW/NW-side conditions may refer to NW and infrastructure settings that are capable of being quantified and signaled to the UE side, while NW additional conditions may correspond to NW and infrastructure settings that are hard or more difficult to quantify or signal explicitly to the UE side. This may also apply to the UE side. For example, UE/UE-side conditions may refer to UE settings that are capable of being quantified and signaled to the NW side, while UE additional conditions may correspond to UE settings that are hard or more difficult to quantify or signal explicitly to the NW side. Also, information and/or indication on network-side conditions may also be provided to UE. However, some datasets associated with the AI/ML model training may not be identifiable between different network entities/nodes (e.g., between a UE, a location server, and/or a base station, etc.), which may affect the overall performance and efficiency of the AI/ML model training.

As an illustration, an existing site/scenario may experience changes due to two factors. The first factor may be that TRP(s) and/or base station(s) may change their positioning configurations (e.g., PRS beam assignments and shapes, PRS transmission (TX) powers, TRP locations, etc.) from time to time. However, some of these TRP positioning configurations at a base station may not be exposed to a UE (e.g., due to proprietary concerns). This may also apply to proprietary details at the UE side. The second factor may be that the radio characteristics/statistics of underlying wireless channel may also experience significant changes due to mobility of background (e.g., blockers and reflectors), but it may take a new UE moving to the site and a lengthy time to accurately pin-point actual radio characteristics/statistics (e.g., due to lengthy process specified to characterize radio characteristics/statistics by collecting sufficiently large number of measurements).

As such, dataset collection may be specified to scope multiple datasets that are structured and organized for different positioning configurations and/or radio characteristics/statistics. For example, if a UE is training one or multiple AI/ML models based on a set of datasets, the UE may specify a mechanism that enables the UE to match the suitable/right AI/ML model(s) to positioning configurations or radio characteristics/statistics. The same concept may also apply to the training of the AI/ML models at the network side (e.g., at the location server and the base stations). In another example, a UE may request assistance from a location server (e.g., an LMF) to pick a suitable/right AI/ML model that is capable of fitting a set of undisclosed positioning configurations and/or radio characteristics/statistics. However, the location server may be specified to provide such assistance without explicitly disclosing positioning configurations or may ask the UE to spend a long time characterizing the underlying channel radio characteristics/statistics. Similar situations may also apply to the location server and/or base station(s).

Aspects presented herein may improve the overall performance and efficiency for AI/ML model training at different network entities/nodes (e.g., at a UE, a base station, a set of TRPs, a location server, etc.), where one or more AI/ML models may be trained for different/possible positioning configurations and radio characteristics/statistics. Aspects presented herein may enable a network entity/node to match a suitable/right AI/ML model for a set of configurations (which the network entity/node may not know) and radio characteristics/statistics. For example, based on an initiation from a network entity/node, a set of corresponding positioning configurations may be logged and be associated with respective dataset identifiers by multiple network entities/nodes. The measurements associated with these positioning configurations may be used to train one or more AI/ML positioning models. During an operation, a network entity/node may determine a dataset identifier to be used based on the current positioning configuration, communicate to another network entity/node the dataset identifier to be used and determine the AI/ML model to be used based on the data identifier. In another example, a location server may be configured to identify the dataset identifier to be used, and communicate it to a UE and a base station to enable them to pick a suitable/correct AI/ML model.

In one aspect of the present disclosure, a group of network entities, which may include at least one UE, at least one location server (e.g., an LMF), and/or at least one base station (which may include a set of TRPs) may be configured to index/mark data during dataset collection with a specified identifier/identification (ID) for which this ID may be used (later) for coordination between network entities (e.g., between the at least one UE, the at least on location server, and/or the at least one base station). The data (which may also be referred to as the “dataset”) may include any data related (directly or indirect) to the AI/ML model training, such as measurements (e.g., CIR, CFR, PDP, DP, and/or RSRP, etc.) of positioning reference signals, location of the measurements, sources of the positioning reference signals, etc. In addition, the ID may be used by the network entities for AI/ML-related life cycle management (LCM), such as selection, activation, deactivation, switching, and/or fallback of AI/ML model(s) for AI/ML positioning cases (e.g., as described in connection with FIGS. 7, 8A, 8B, 9A, and 9B).

In one example, at least one of a UE, a location server (e.g., an LMF), or a base station may be configured with the capability to initiate dataset indexing (e.g., referring to the marking/indexing of the data during dataset collection). For example, the UE may initiate dataset indexing by raising/transmitting a request to the location server. Based on the request, the location server may select and release an ID back to the UE, such that the UE may mark/index the dataset with the ID during or after the dataset collection. Similarly, the base station may also initiate dataset indexing by raising/transmitting a request to the location server. Based on the request, the location server may also select and release an ID back to the base station for the base station to mark/index the dataset with the ID during or after the dataset collection. In another example, the location server may initiate dataset indexing, and notify the UE and/or the base station about the ID to be used for the dataset indexing (e.g., after the location server selects the ID). In addition to the dataset indexing, the network entities may also be configured to log their positioning configurations and/or radio characteristics/statistics at the time the ID is selected, released, and/or provided to them. The transmission/release of ID may specify certain signaling and aspects to properly assign and manage IDs and apply LCM. For example, LTE positioning protocol (LPP) and/or NR positioning protocol A (NRPPa) signaling may be used for enabling the dataset indexing/marking between the UE, the location server, and the base station.

For purposes of the present disclosure, the dataset indexing/marking may happen while a dataset collection session (e.g., a period of time or a condition in which a network entity is configured to collect data that can be used for AI/ML training purposes) is active and running. However, this dataset collection process may not be visible to another network entity. For example, when a UE or a base station is configured to index/mark a set of datasets during a dataset collection session, the dataset collection process may not be visible to a location server (e.g., the location server may not be aware of the dataset collection performed by the UE/base station). Similarly, when the LMF is configured to index/mark a set of datasets during a dataset collection session, the dataset collection process may not be visible to the UE and/or the base station. Such scenario may occur because dataset collection may be proprietary and happening in the background. As such, the dataset indexing/marking may provide an efficient/effective way to let different/another network entities know that dataset collection may be active in at least one of the network entities on certain time occasion(s), such that multiple/different network entities (e.g., the UE/base station and the location server) may obtain a proper annotation (e.g., an index or a dataset ID) to keep track on configurations and radio characteristics/statistics over the time occasion(s) and use this annotation for future reference to apply AI/ML functionality/model and LCM. Also, the dataset index may be used in association with an AI/ML positioning functionality, logical model, or physical model and may be applicable to all of them (e.g., including functionality or model ID based LCM).

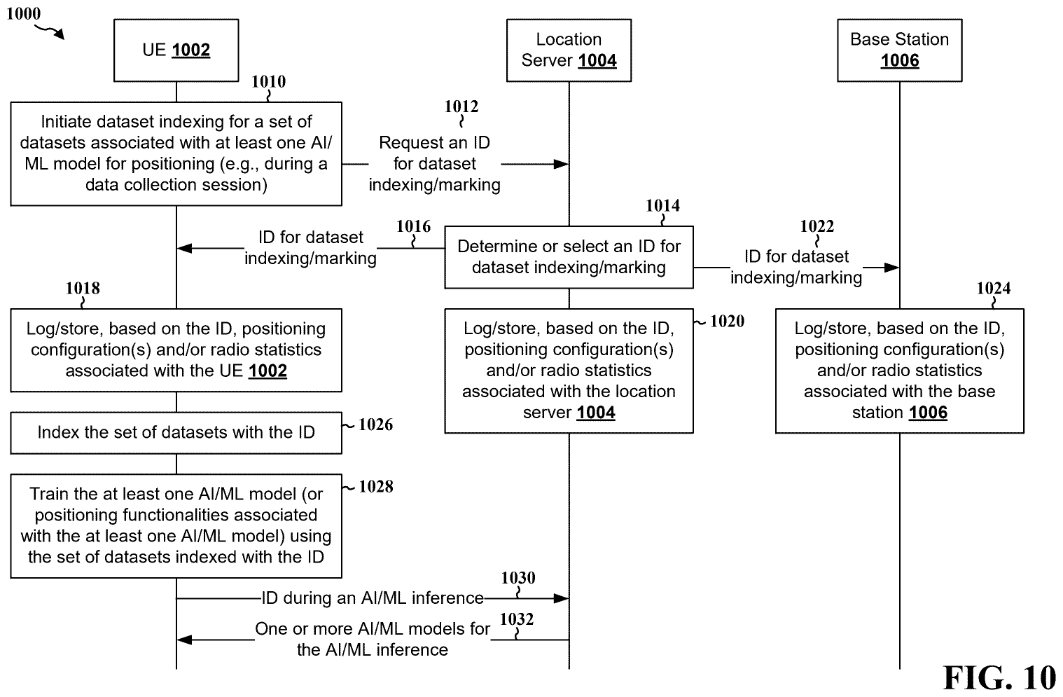

FIG. 10 is a communication flow 1000 illustrating an example procedure of a UE-initiated dataset indexing in accordance with various aspects of the present disclosure. The numberings associated with the communication flow 1000 do not specify a particular temporal order and are merely used as references for the communication flow 1000. In one configuration, a UE may request a location server (e.g., an LMF) to mark/provide a dataset identifier. In response, the location server may select and assign a dataset identifier and provide it back to the UE. The location server may log its related positioning configurations at the time the dataset identifier has been marked and assigned, and the UE may also be configured to log its related positioning configurations. The location server may also provide the dataset identifier to a base station (e.g., a serving base station of the UE or a base station participating in the positioning of the UE, etc.), and notify the base station (which may include TRPs of the base station) to log positioning configurations at their side. The UE, the location server, and/or the base station may be configured to also log their radio characteristics/statistics at the time the dataset identifier is obtained. Later on, the UE, the base station, and/or the location server may perform AI/ML model training or inference based on the dataset identifier (e.g., such as by referring to logged positioning configurations and radio statistics associated with the dataset identifier).

For example, at 1010, a UE 1002 (e.g., a first network entity) may initiate dataset indexing/marking for a set of datasets associated with the at least one AI/ML model (e.g., an AI/ML model that is to be used in associated with positioning). The dataset indexing/marking may be performed during and/or after a dataset collection session.

At 1012, after the UE 1002 initiates the dataset indexing, the UE 1002 may transmit, to a location server 1004 (e.g., a second network entity), a request for an identifier (ID) to be used for indexing the set of datasets associated with the at least one AI/ML model. In other words, the transmission of the request may be based on the initiation of the dataset indexing.

At 1014, based on the request from the UE 1002, the location server 1004 may determine/select an ID to be used for the dataset indexing/marking. Then, as shown at 1016, the location server 1004 may transmit the determined/selected ID to the UE 1002. In some implementations, the location server 1004 may also transmit, to the UE 1002, an indication to log/store its positioning configurations and/or radio statistics with the ID (or this may be implicit where the UE 1002 is configured to log/store its positioning configurations and/or radio statistics when/after receiving the ID).

At 1018, after receiving the ID from the location server 1004 and/or based on the received ID, the UE 1002 may be configured to log (e.g., store) positioning configurations and/or radio characteristics/statistics associated with the UE 1002 (that are related to the dataset collection session) with the ID. In addition, at 1020, after selecting/determining the ID or after transmitting the ID to the UE 1002, the location server 1004 may also be configured to log (e.g., store) positioning configurations and/or radio characteristics/statistics associated with the location server 1004 with the ID. In some implementations, at 1022, the location server 1004 may also transmit/forward the ID to a base station 1006, which may be a serving base station of the UE 1002 or a base station participating in or associated with the positioning session of the UE 1002. In some implementations, the location server 1004 may also transmit, to the base station 1006, an indication to log/store its positioning configurations and/or radio statistics with the ID (or this may be implicit where the base station 1006 is configured to log/store its positioning configurations and/or radio statistics when/after receiving the ID). Similarly, at 1024, based on the received ID, the base station 1006 may be configured to log (e.g., store) positioning configurations and/or radio characteristics/statistics associated with the base station 1006 with the ID. At 1026, the UE 1002 may also index/mark the set of datasets with the ID, such as during or after the dataset collection session.

Depending on the implementations, the ID/dataset identifier may include one or more of the following attributes: (1) a unique identifier, (2) a cell ID, radio access network (RAN) area ID, a tracking area ID, etc., (3) a coordinated universal time (UTC) timing plus date, (4) a start/stop timing and date, (5) landmark fix information (e.g., latitude, longitude, and/or elevation, or unique location information of a nearby landmark such as building address that is publicly known), (6) an expiry time for the ID, or a combination thereof. In some examples, the location server 1004 (e.g., an LMF) may obtain the ID by coordinating with another network entity, where the ID may be a local ID or a global ID.

The positioning configuration(s) that may be logged/stored by the UE 1002, the location server 1004, and/or the base station 1006 may include proprietary configurations at the UE 1002, the location server 1004, and/or the base station 1006 that are not disclosed to the other network entities, which may include one or more of the followings: (1) a set of downlink (DL) positioning reference signal (PRS) beam shapes, (2) a DL PRS antenna pattern, configuration, or down-tilting, (3) a DL PRS transmission (TX) power, (4) a set of radio unit locations or transmission reception point (TRP) locations, (5) a mapping of PRS resources to a set of TRP physical locations, (6) an UL sounding reference signal (SRS) TX power, (7) a set of UE SRS beam shapes, (8) a UE antenna pattern or a set of configurations used for sensing SRS, or (9) a combination thereof.

The radio characteristic(s) that may be logged/stored by the UE 1002, the location server 1004, and/or the base station 1006 may include or related to statistics (e.g., mean, k-percentile, or range, etc.) of PRS/SRS resources sent between the base station 1006 and the UE 1002, such as (1) a signal to interference plus noise ratio (SINR) distribution, (2) a set of reference signal received power (RSRP) measurements, (3) a Rician factor, (4) a delay spread, (5) a Doppler spread, or (6) a combination thereof.

At 1028, the UE 1002 may train the at least one AI/ML model (or positioning functionalities associated with the at least one AI/ML model) using the set of datasets indexed with the ID. For example, this may apply to the UE-side AI/ML positioning model as described in connection with FIGS. 7 and 8A.

In some implementations, during an AI/ML inference or operation session, the UE 1002 may use the ID to request the location server 1004 to provide an AI/ML model to be used for the AI/ML inference or operation session. For example, at 1030, the UE 1002 may send the ID to the location server 1004. Then, at 1032, based on the positioning configuration(s) and/or radio characteristics/statistics associated with the location server 1004 that are logged/stored with the ID, the location server 1004 may indicate/recommend one or more AI/ML models to the UE 1002 for the AI/ML inference or operation session.

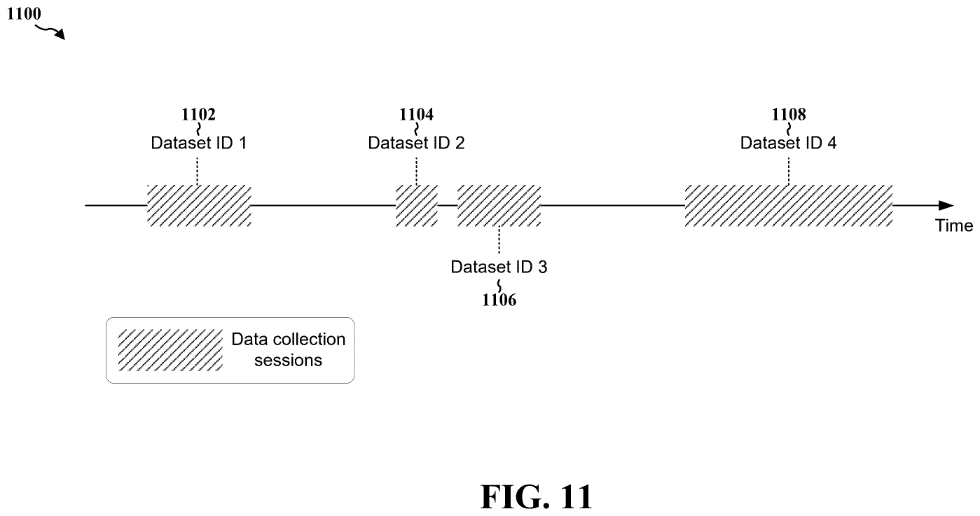

FIG. 11 is a diagram 1100 illustrating an example of dataset indexing/marking over time in accordance with various aspects of the present disclosure. Based on the assigned/selected ID(s), a network entity may perform dataset indexing/marking for dataset collected from different dataset collection sessions. For example, dataset collected at a first dataset collection session may be indexed/marked with a first ID (ID 1) as shown at 1102, dataset collected at a second dataset collection session may be indexed/marked with a second ID (ID 2) as shown at 1104, dataset collected at a third dataset collection session may be indexed/marked with a third ID (ID 3) as shown at 1106, and dataset collected at a fourth dataset collection session may be indexed/marked with a fourth ID (ID 4) as shown at 1108, etc.

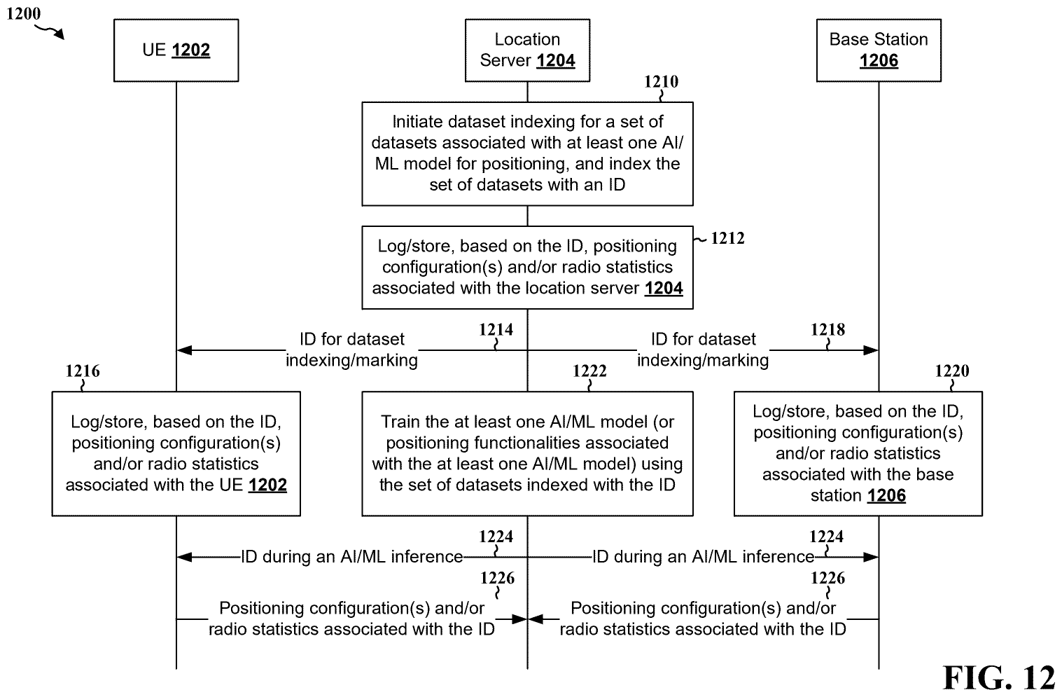

FIG. 12 is a communication flow 1200 illustrating an example procedure of a location server (e.g., LMF)-initiated dataset indexing in accordance with various aspects of the present disclosure. The numberings associated with the communication flow 1200 do not specify a particular temporal order and are merely used as references for the communication flow 1200. In one configuration, a location server (e.g., an LMF) may initiate and index/mark a set of datasets with a dataset identifier. Then, the location server may transmit the dataset identifier to a UE. The location server may log its related positioning configurations when or after the dataset identifier has been used for indexing/marking the set of datasets, and the UE may also be configured to log its related positioning configurations after receiving the dataset identifier. The location server may also provide the dataset identifier to a base station (e.g., a serving base station of the UE or a base station participating in the positioning of the UE, etc.), and notify the base station to log its positioning configurations. The location server, the UE, and/or the base station may be configured to also log their radio characteristics/statistics at the time the dataset identifier is obtained. Later on, the UE, the base station, and/or the location server may perform AI/ML model training or inference based on the dataset identifier (e.g., such as by referring to logged positioning configurations and radio statistics associated with the dataset identifier).

For example, at 1210, a location server 1204 (e.g., a first network entity) may initiate dataset indexing/marking for a set of datasets associated with the at least one AI/ML model (e.g., an AI/ML model that is to be used in associated with positioning), and index/mark the set of datasets with an ID. The dataset indexing/marking may be performed during and/or after a dataset collection session.

At 1212, the location server 1204 may also be configured to log (e.g., store) positioning configurations and/or radio characteristics/statistics associated with the location server 1204 with the ID.

At 1214, after the location server 1204 initiates the dataset indexing and/or indexing/market the set of datasets, the location server 1204 may transmit the ID to a UE 1202 (e.g., a second network entity). In some implementations, the location server 1204 may also transmit, to the UE 1202, an indication to log/store its positioning configurations and/or radio statistics with the ID (or this may be implicit where the UE 1202 is configured to log/store its positioning configurations and/or radio statistics when/after receiving the ID).

At 1216, after receiving the ID from the location server 1204 and/or based on the received ID, the UE 1202 may be configured to log (e.g., store) positioning configurations and/or radio characteristics/statistics associated with the UE 1202 (that are related to the dataset collection session) with the ID. Similarly, at 1218, the location server 1204 may also transmit the ID to a base station 1206 (e.g., a third network entity, a serving base station for the UE 1202, a base station participating in the positioning of the UE 1202, etc.). In some implementations, the location server 1204 may also transmit, to the base station 1206, an indication to log/store its positioning configurations and/or radio statistics with the ID (or this may be implicit where the base station 1206 is configured to log/store its positioning configurations and/or radio statistics when/after receiving the ID). At 1220, after receiving the ID from the location server 1204 and/or based on the received ID, the base station 1206 may be configured to log (e.g., store) positioning configurations and/or radio characteristics/statistics associated with the base station 1206 (that are related to the dataset collection session) with the ID. In some examples, the location server 1204 may also transmit an indication to the UE 1202 and/or the base station 1206 to log their positioning configurations and/or radio characteristics/statistics associated based on the ID, where the UE 1202 and/or the base station 1206 may log their positioning configurations and/or radio characteristics/statistics based on the received indication.

As described in connection with FIG. 10, the ID/dataset identifier may include one or more of the following attributes: (1) a unique identifier, (2) a cell ID, an RAN area ID, a tracking area ID, etc., (3) an UTC timing plus date, (4) a start/stop timing and date, (5) landmark fix information (e.g., latitude, longitude, and/or elevation, or unique location information of a nearby landmark such as building address that is publicly known), (6) an expiry time for the ID, or a combination thereof. In some examples, the location server 1204 (e.g., an LMF) may obtain the ID by coordinating with another network entity, where the ID may be a local ID or a global ID. The positioning configuration(s) that may be logged/stored by the UE 1202, the location server 1204, and/or the base station 1206 may include proprietary configurations at the UE 1202, the location server 1204, and/or the base station 1206 that are not disclosed to the other network entities, which may include one or more of the followings: (1) a set of DL PRS beam shapes, (2) a DL PRS antenna pattern, configuration, or down-tilting, (3) a DL PRS TX power, (4) a set of radio unit locations or TRP locations, (5) a mapping of PRS resources to a set of TRP physical locations, (6) an UL SRS TX power, (7) a set of UE SRS beam shapes, (8) a UE antenna pattern or a set of configurations used for sensing SRS, or (9) a combination thereof. The radio characteristic(s) that may be logged/stored by the UE 1202, the location server 1204, and/or the base station 1206 may include or related to statistics (e.g., mean, k-percentile, or range, etc.) of PRS/SRS resources sent between the base station 1206 and the UE 1202, such as (1) an SINR distribution, (2) a set of RSRP measurements, (3) a Rician factor, (4) a delay spread, (5) a Doppler spread, or (6) a combination thereof.

At 1222, the location server may train the at least one AI/ML model (or positioning functionalities associated with the at least one AI/ML model) using the set of datasets indexed with the ID. For example, this may apply the LMF-side AI/ML positioning model as described in connection with FIGS. 8B and 9B.

In some implementations, during an AI/ML inference or operation session, the location server 1204 may use the ID to request the UE 1202 and/or the base station 1206 to provide their positioning configuration(s) and/or radio characteristics/statistics associated with the ID, which may be used for the AI/ML inference or operation session. For example, at 1224, the location server 1204 may send the ID to the UE 1202 and/or the base station 1206. Then, at 1226, in response to the received ID, the UE 1202 and/or the base station 1206 may transmit their positioning configuration(s) and/or radio characteristics/statistics associated with the ID to the location server 1204, where the location server 1204 may use these positioning configuration(s) and/or radio characteristics/statistics as part of the AI/ML inference or operation session. In some examples, in response to the received ID, the UE 1202 and/or the base station 1206 may also indicate, to the location server 1204, one or more AI/ML models or functionalities they used associated with the ID.

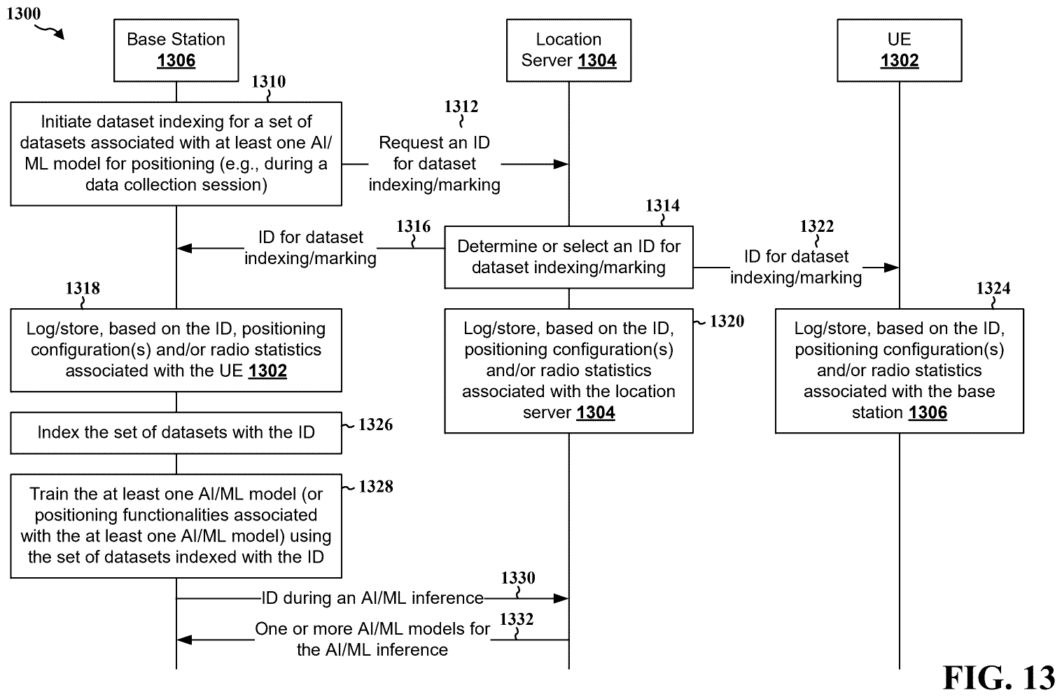

FIG. 13 is a communication flow 1300 illustrating an example procedure of a base station (e.g., gNB)-initiated dataset indexing in accordance with various aspects of the present disclosure. The numberings associated with the communication flow 1300 do not specify a particular temporal order and are merely used as references for the communication flow 1300. In one configuration, a base station may request a location server (e.g., an LMF) to mark/provide a dataset identifier. In response, the location server may select and assign a dataset identifier and provide it back to the base station. The location server may log its related positioning configurations at the time the dataset identifier has been marked and assigned, and the base station may also be configured to log its related positioning configurations. The location server may also provide the dataset identifier to a UE (e.g., the base station may be a serving base station of the UE or a base station participating in the positioning of the UE, etc.), and notify the UE to log positioning configurations at the UE side. The base station, the location server, and/or the UE may be configured to also log their radio characteristics/statistics at the time the dataset identifier is obtained. Later on, the UE, the base station, and/or the location server may perform AI/ML model training or inference based on the dataset identifier (e.g., such as by referring to logged positioning configurations and radio statistics associated with the dataset identifier).

For example, at 1310, a base station 1306 (e.g., a first network entity) may initiate dataset indexing/marking for a set of datasets associated with the at least one AI/ML model (e.g., an AI/ML model that is to be used in associated with positioning). The dataset indexing/marking may be performed during and/or after a dataset collection session.

At 1312, after the base station 1306 initiates the dataset indexing, the base station 1306 may transmit, to a location server 1304 (e.g., a second network entity), a request for an ID to be used for indexing the set of datasets associated with the at least one AI/ML model. In other words, the transmission of the request may be based on the initiation of the dataset indexing.

At 1314, based on the request from the base station 1306, the location server 1304 may determine/select an ID to be used for the dataset indexing/marking. Then, as shown at 1316, the location server 1304 may transmit the determined/selected ID to the base station 1306. In some implementations, the location server 1304 may also transmit, to the UE 1302, an indication to log/store its positioning configurations and/or radio statistics with the ID (or this may be implicit where the UE 1302 is configured to log/store its positioning configurations and/or radio statistics when/after receiving the ID).

At 1318, after receiving the ID from the location server 1304 and/or based on the received ID, the base station 1306 may be configured to log (e.g., store) positioning configurations and/or radio characteristics/statistics associated with the base station 1306 (that are related to the dataset collection session) with the ID. In addition, at 1320, after selecting/determining the ID or after transmitting the ID to the base station 1306, the location server 1304 may also be configured to log (e.g., store) positioning configurations and/or radio characteristics/statistics associated with the location server 1304 with the ID. In some implementations, at 1322, the location server 1304 may also transmit/forward the ID to a UE 1302, which may be a UE served by the base station 1306 or a UE using the base station in association with the positioning. The location server 1304 may also transmit, to the base station 1306, an indication to log/store its positioning configurations and/or radio statistics with the ID (or this may be implicit where the base station 1306 is configured to log/store its positioning configurations and/or radio statistics when/after receiving the ID). Similarly, at 1324, based on the received ID, the UE 1302 may be configured to log (e.g., store) positioning configurations and/or radio characteristics/statistics associated with the UE 1302 with the ID. At 1326, the base station 1306 may also index/mark the set of datasets with the ID, such as during or after the dataset collection session.

As described in connection with FIG. 10, the ID/dataset identifier may include one or more of the following attributes: (1) a unique identifier, (2) a cell ID, an RAN area ID, a tracking area ID, etc., (3) an UTC timing plus date, (4) a start/stop timing and date, (5) landmark fix information (e.g., latitude, longitude, and/or elevation, or unique location information of a nearby landmark such as building address that is publicly known), (6) an expiry time for the ID, or a combination thereof. In some examples, the location server 1304 (e.g., an LMF) may obtain the ID by coordinating with another network entity, where the ID may be a local ID or a global ID. The positioning configuration(s) that may be logged/stored by the UE 1302, the location server 1304, and/or the base station 1306 may include proprietary configurations at the UE 1302, the location server 1304, and/or the base station 1306 that are not disclosed to the other network entities, which may include one or more of the followings: (1) a set of DL PRS beam shapes, (2) a DL PRS antenna pattern, configuration, or down-tilting, (3) a DL PRS TX power, (4) a set of radio unit locations or TRP locations, (5) a mapping of PRS resources to a set of TRP physical locations, (6) an UL SRS TX power, (7) a set of UE SRS beam shapes, (8) a UE antenna pattern or a set of configurations used for sensing SRS, or (9) a combination thereof. The radio characteristic(s) that may be logged/stored by the UE 1302, the location server 1304, and/or the base station 1306 may include or related to statistics (e.g., mean, k-percentile, or range, etc.) of PRS/SRS resources sent between the base station 1306 and the UE 1302, such as (1) an SINR distribution, (2) a set of RSRP measurements, (3) a Rician factor, (4) a delay spread, (5) a Doppler spread, or (6) a combination thereof.

At 1328, the base station 1306 may train the at least one AI/ML model (or positioning functionalities associated with the at least one AI/ML model) using the set of datasets indexed with the ID. For example, this may apply the base station-side AI/ML positioning model as described in connection with FIG. 9A.

In some implementations, during an AI/ML inference or operation session, the base station 1306 may use the ID to request the location server 1304 to provide an AI/ML model to be used for the AI/ML inference or operation session. For example, at 1330, the base station 1306 may send the ID to the location server 1304. Then, at 1332, based on the positioning configuration(s) and/or radio characteristics/statistics associated with the location server 1304 that are logged/stored with the ID, the location server 1304 may indicate/recommend one or more AI/ML models to the base station 1306 for the AI/ML inference or operation session.

In some implementations, if a UE (e.g., the UE 1002, 1202, 1302) supports UE-side AI/ML positioning (e.g., as described in connection with FIGS. 7 and 8A) and is assigned with an ID for dataset indexing/marking from a location server (e.g., the location server 1004, 1204, 1304), e.g., as described in connection with 1016, 1214, or 1322, etc., the UE may be configured to indicate to the location server regarding its capability of supporting the UE-side AI/ML positioning, and that the UE-side AI/ML positioning may be valid for a set of positioning configurations and/or a set of radio characteristics/statistics used (e.g., such as by flagging the ID). Then, the UE may receive, from the location server, signaling or an indication to apply a life cycle management (LCM) action (e.g., activation, deactivation, selection, switching, or fallback, etc.) for at least one UE-side AI/ML positioning model and/or functionality. In some scenarios, the location server may also take an LCM action to a location server-side (e.g., LMF-side) positioning model, and/or may request a base station (including its TRP(s)) (e.g., the base station 1006, 1206, 1306) to apply adjustment(s) to their positioning configurations to match those of the ID.

For example, referring back to FIG. 10, the UE 1002 may transmit, to the location server 1004, an indication of supporting UE-side AI/ML positioning that is valid for at least one of positioning configurations or radio characteristics/statistics. Based on the indication, the location server 1004 may request the UE 1002 to apply an LCM for at least one AI/ML model or for a set of functionalities associated with the at least one AI/ML model. The LCM may include: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, and/or falling back to a previous AI/ML model or a previous set of functionalities, etc. In some implementations, the UE 1002 may send/indicate a list of supported ID(s) to the location server 1004 as part of the LPP UE capability exchange messaging.

Similarly, if a base station (e.g., the base station 1006, 1206, 1306) supports base station-side AI/ML positioning (e.g., as described in connection with FIG. 9A) and is assigned with an ID for dataset indexing/marking from a location server (e.g., the location server 1004, 1204, 1304), e.g., as described in connection with 1022, 1218, or 1316, etc., the base station may be configured to indicate to the location server regarding its capability of supporting the base station-side AI/ML positioning, and that the base station-side AI/ML positioning may be valid for a set of positioning configurations and/or a set of radio characteristics/statistics used (e.g., such as by flagging the ID). Then, the base station may receive, from the location server, signaling or an indication to apply a life cycle management (LCM) action (e.g., activation, deactivation, selection, switching, or fallback, etc.) for at least one base station-side AI/ML positioning model and/or functionality. In some scenarios, the location server may also take an LCM action to a location server-side (e.g., LMF-side) positioning model, and/or may request a base station (including its TRP(s)) (e.g., the base station 1006, 1206, 1306) to apply adjustment(s) to their positioning configurations to match those of the ID.

For example, referring back to FIG. 13, the base station 1306 may transmit, to the location server 1304, an indication of supporting base station-side AI/ML positioning that is valid for at least one of positioning configurations or radio characteristics/statistics. Based on the indication, the location server 1304 may request the base station 1306 to apply an LCM for at least one AI/ML model or for a set of functionalities associated with the at least one AI/ML model. The LCM may include: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, and/or falling back to a previous AI/ML model or a previous set of functionalities, etc. In some implementations, the base station 1306 may send/indicate a list of supported ID(s) to the location server 1304 as part of the NRPPa TRP information exchange messaging.

In some implementations, a location server (e.g., the location server 1004, 1204, 1304) may also indicate to a UE (e.g., the UE 1002, 1202, 1302) and/or a base station (e.g., the base station 1006, 1206, 1306) regarding its capability to run one or more AI/ML positioning enabled features (e.g., as described in connection with FIGS. 8B and 9B) that are valid for a set of positioning configurations and/or a set of radio characteristics/statistics used when the ID has been assigned/selected. In response, the UE and/or the base station may adjust their positioning configurations to match those of the ID.

For example, referring back to FIG. 12, the location server 1204 may transmit, to the UE 1202 and/or the base station 1206, an indication of running an AI/ML positioning enabled feature that is valid for a set of positioning configurations and/or a set of radio characteristics/statistics when the ID has been assigned (e.g., and transmitted to the UE 1202 and/or the base station 1206). In response to the indication, the UE 1202 and/or the base station 1206 may be configured to modify or adjust their positioning configurations and/or radio characteristics/statistics based on the ID. In one example, the location server 1204 may send to the UE 1202 and/or the base station 1206 a flag of the ID using the LPP and/or the NRPPa signaling. In another example, the location server may send this flag of the ID as part of a broadcast message (e.g., a system information block (SIB) dedicated for AI/ML operations [e.g., an aimlSIB]), which may be targeting to multiple UEs.

Note in some scenarios, a UE that obtains the ID may not be the same as the UE indicating the capability and applying the LCM. For example, a first UE may be a dataset collection UE while a second UE may be another UE having an AI/ML model trained based on dataset collected by the first UE. This aspect may also apply to the base station and the location server (e.g., there may be multiple/different base stations and/or locations servers that are configured to indicate the capability/apply the LCM, or to be trained based on datasets collected by other base station(s)/locations server(s)).

In another aspect of the present disclosure, the ID(s) (e.g., for dataset indexing/marking in at least one network entity) may be specified to be maintained from time to time. As such, in some implementations, it may be important to enable/allow the UE, the location server, and/or the base station to apply the maintenance of dataset IDs, such as to indicate their expiry and/or replace their IDs. For example, a location server (e.g., the location server 1004, 1204, 1304) may determine to abort an ID because a set of corresponding location server configurations are no longer used. In this case, the location server may send an abort message or an indication to one or more UEs (which may be UE/UE-group specific or targeted as a broadcast message for all UEs, etc.) or to one or more base stations/TRPs. The location server may also be specified to apply maintenance of dataset IDs, for example, the location sever may be specified to replace an ID with a new one. There may be a specified message to enable/allow modifying attributes of an ID. The same concept/aspect may also be applied to the UE/base station side. For example, a UE (e.g., the UE 1002, 1202, 1302) and/or a base station (e.g., the base station 1006, 1206, 1306) may indicate to a location server that an ID is no longer valid, and request/ask the location server to abort, cancel, or replace that ID.

Aspects presented herein may improve the overall performance and efficiency for AI/ML model training at different network entities/nodes (e.g., at a UE, a base station, a set of TRPs, a location server, etc.), where one or more AI/ML models may be trained for different/possible positioning configurations and radio characteristics/statistics. Proprietary configuration changes on the base station (e.g., gNB)-side may not be exposed to the UE and vice versa. There may also be radio characteristics/statistics changes to the underlying wireless channels. AI/ML models may specify to be trained for possible configurations and radio characteristics/statistics, additionally a UE/base station may be specified to match the suitable/right AI/ML model for a set of configurations (which the UE/base station may not know) and radio characteristics/statistics. In one aspect of the present disclosure, at one or more times, based on initiations from UE/gNB/LMF, sets of corresponding UE and gNB positioning configurations may be logged and be associated with respective dataset identifiers. The measurements associated with these UE and gNB positioning configurations may be used to train one or more AI/ML positioning models. During an operation, a UE/gNB may determine the dataset identifier to be used based on the current UE/gNB positioning configuration, communicate to the gNB/UE the dataset identifier to be used and determine the AI/ML model to be used based on the data identifier. In another aspect of the present disclosure, during the operation, the LMF may identify the dataset identifier to be used, communicate it to the UE and gNB and the suitable/correct AI/ML model may be picked. In another aspect of the present disclosure, radio characteristics/statistics may be logged along with the positioning configurations. In another aspect of the present disclosure, a UE may indicate to the LMF its ability to support AI/ML positioning and its supported dataset identifiers via a capability exchange. In another aspect of the present disclosure, a gNB may indicate to the LMF its ability to support AI/ML positioning and its supported dataset identifiers via an NRPPa TRP information exchange.

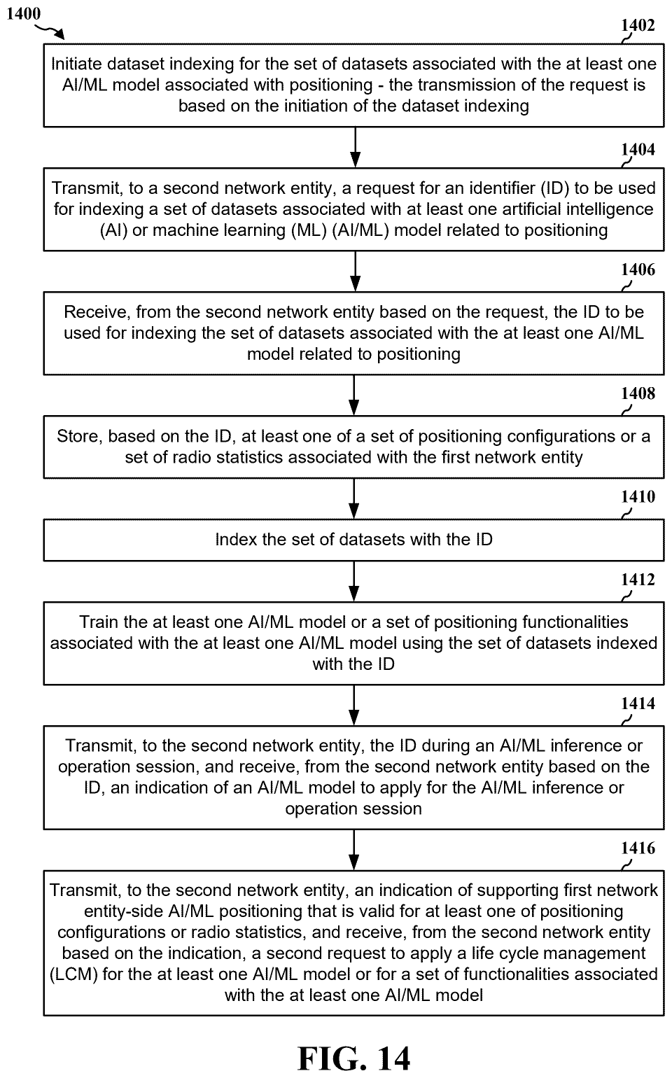

FIG. 14 is a flowchart 1400 of wireless communication. The method may be performed by a first network entity (e.g., the UE 104, 404, 602, 702, 1002, 1402; the apparatus 1604; the base station 102, 706, 1006, 1406; the network entity 1702). The method may enable the first network entity to request an ID for indexing/marking datasets associated with AI/ML model training. Then, multiple network entities may use the ID for AI/ML related positioning training and inference to enable a consistency between the network entities.

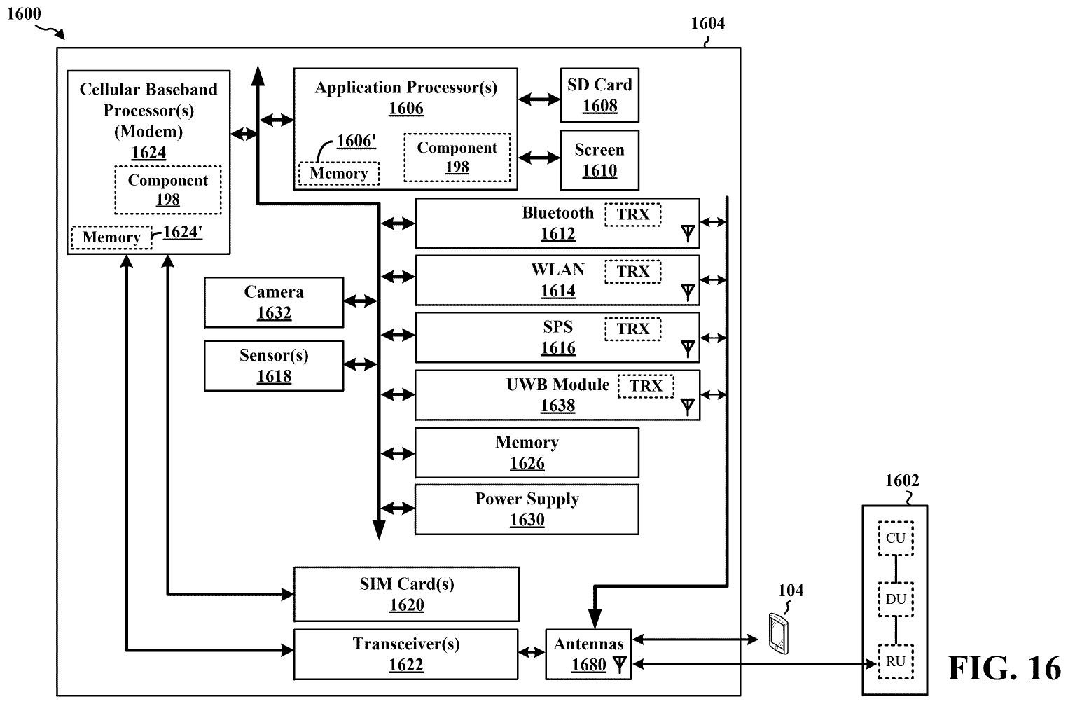

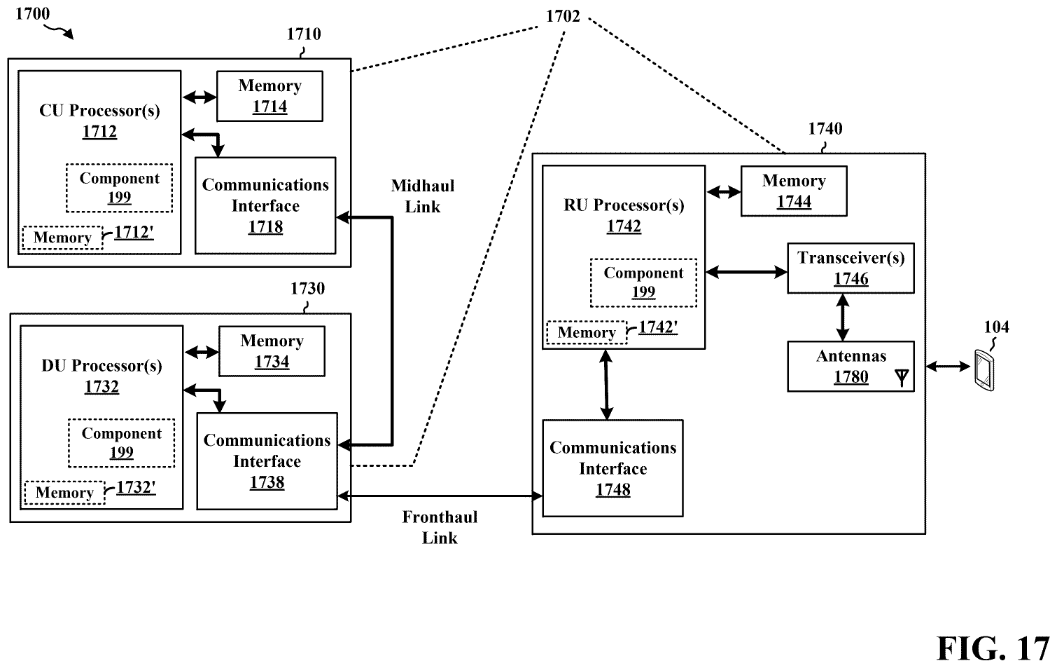

At 1404, the first network entity may transmit, to a second network entity, a request for an ID to be used for indexing a set of datasets associated with at least one AI/ML model related to positioning, such as described in connection with FIGS. 10, 11 and 13. For example, as discussed in connection with 1012 of FIG. 10, the UE 1002 may transmit, to a location server 1004 (e.g., a second network entity), a request for an identifier (ID) to be used for indexing the set of datasets associated with the at least one AI/ML model. The transmission of the request may be performed by, e.g., the dataset ID processing component 198, the transceiver(s) 1622, the cellular baseband processor(s) 1624, and/or the application processor(s) 1606 of the apparatus 1604 in FIG. 16. The transmission of the request may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

At 1406, the first network entity may receive, from the second network entity based on the request, the ID to be used for indexing the set of datasets associated with the at least one AI/ML model related to positioning, such as described in connection with FIGS. 10, 11 and 13. For example, as discussed in connection with 1016 of FIG. 10, the UE 1002 may receive, from the location server 1004 based on the request, an ID determined/selected by the location server 1004 for indexing the set of datasets associated with the at least one AI/ML model related to positioning. The reception of the ID may be performed by, e.g., the dataset ID processing component 198, the transceiver(s) 1622, the cellular baseband processor(s) 1624, and/or the application processor(s) 1606 of the apparatus 1604 in FIG. 16. The reception of the ID may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

At 1408, the first network entity may store, based on the ID, at least one of a set of positioning configurations or a set of radio statistics associated with the first network entity, such as described in connection with FIGS. 10, 11 and 13. For example, as discussed in connection with 1018 of FIG. 10, after receiving the ID from the location server 1004 and/or based on the received ID, the UE 1002 may be configured to log (e.g., store) positioning configurations and/or radio characteristics/statistics associated with the UE 1002 (that are related to the dataset collection session) with the ID. The store of the ID may be performed by, e.g., the dataset ID processing component 198, the transceiver(s) 1622, the cellular baseband processor(s) 1624, and/or the application processor(s) 1606 of the apparatus 1604 in FIG. 16. The store of the ID may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

At 1410, the first network entity may index the set of datasets with the ID, such as described in connection with FIGS. 10, 11 and 13. For example, as discussed in connection with 1026 of FIG. 10, the UE 1002 may also index/mark the set of datasets with the ID, such as during or after the dataset collection session. The indexing of the set of datasets may be performed by, e.g., the dataset ID processing component 198, the transceiver(s) 1622, the cellular baseband processor(s) 1624, and/or the application processor(s) 1606 of the apparatus 1604 in FIG. 16. The indexing of the set of datasets may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In one example, as shown at 1402, the first network entity may initiate dataset indexing for the set of datasets associated with the at least one AI/ML model associated with positioning, where the transmission of the request is based on the initiation of the dataset indexing, such as described in connection with FIGS. 10, 11 and 13. For example, as discussed in connection with 1010 of FIG. 10, the UE 1002 may initiate dataset indexing/marking for the set of datasets associated with the at least one AI/ML model. The initiation of the dataset indexing may be performed by, e.g., the dataset ID processing component 198, the transceiver(s) 1622, the cellular baseband processor(s) 1624, and/or the application processor(s) 1606 of the apparatus 1604 in FIG. 16. The initiation of the dataset indexing may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In another example, as shown at 1412, the first network entity may train the at least one AI/ML model or a set of positioning functionalities associated with the at least one AI/ML model using the set of datasets indexed with the ID, such as described in connection with FIGS. 10, 11 and 13. For example, as discussed in connection with 1028 of FIG. 10, the UE 1002 may train the at least one AI/ML model (or positioning functionalities associated with the at least one AI/ML model) using the set of datasets indexed with the ID. The training of the at least one AI/ML model or a set of positioning functionalities associated with the at least one AI/ML model may be performed by, e.g., the dataset ID processing component 198, the transceiver(s) 1622, the cellular baseband processor(s) 1624, and/or the application processor(s) 1606 of the apparatus 1604 in FIG. 16. The training of the at least one AI/ML model or a set of positioning functionalities associated with the at least one AI/ML model may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In another example, as shown at 1414, the first network entity may transmit, to the second network entity, the ID during an AI/ML inference or operation session, and receive, from the second network entity based on the ID, an indication of an AI/ML model to apply for the AI/ML inference or operation session, such as described in connection with FIGS. 10, 11 and 13. For example, as discussed in connection with 1030 of FIG. 10, the UE 1002 may send the ID to the location server 1004. Then, at 1032, based on the positioning configuration(s) and/or radio characteristics/statistics associated with the location server 1004 that are logged/stored with the ID, the location server 1004 may indicate/recommend one or more AI/ML models to the UE 1002 for the AI/ML inference or operation session. The transmission of the ID and/or the reception of the indication may be performed by, e.g., the dataset ID processing component 198, the transceiver(s) 1622, the cellular baseband processor(s) 1624, and/or the application processor(s) 1606 of the apparatus 1604 in FIG. 16. The transmission of the ID and/or the reception of the indication may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In another example, as shown at 1416, the first network entity may transmit, to the second network entity, an indication of supporting first network entity-side AI/ML positioning that is valid for at least one of positioning configurations or radio statistics, and receive, from the second network entity based on the indication, a second request to apply an LCM for the at least one AI/ML model or for a set of functionalities associated with the at least one AI/ML model, such as described in connection with FIGS. 10 and 13. For example, as discussed in connection with FIG. 10, the UE 1002 may transmit, to the location server 1004, an indication of supporting UE-side AI/ML positioning that is valid for at least one of positioning configurations or radio characteristics/statistics. Based on the indication, the location server 1004 may request the UE 1002 to apply an LCM for at least one AI/ML model or for a set of functionalities associated with the at least one AI/ML model. The transmission of the indication and/or the reception of the second request may be performed by, e.g., the dataset ID processing component 198, the transceiver(s) 1622, the cellular baseband processor(s) 1624, and/or the application processor(s) 1606 of the apparatus 1604 in FIG. 16. The transmission of the indication and/or the reception may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17. In some implementation, the LCM may include at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another example, the first network entity may receive, from the second network entity, an indication of running an AI/ML positioning enabled feature that is valid for at least one of positioning configurations or radio statistics, and modify or adjust, based on the indication, at least one of the set of positioning configurations or the set of radio statistics associated with the first network entity.

In another example, the first network entity may communicate, with the second network entity, an indication to abort using the ID, modifying the ID, or replacing the ID.

In another example, the ID includes at least one of: a unique ID, a cell ID, a RAN area ID, a tracking area ID, a UTC timing plus date, a start/stop timing and date, a landmark fix information, or an expiry time for the ID.

In another example, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another example, the set of radio statistics includes at least one of: an SINR distribution, a set of RSRP measurements, a Rician factor, a delay spread, or a Doppler spread.

In another example, the first network entity is a UE or a base station, and the second network entity is a location server or an LMF.

In another example, to index the set of datasets with the ID, the first network entity may be configured to index the set of datasets with the ID during an active dataset collection session associated with the at least one AI/ML model.

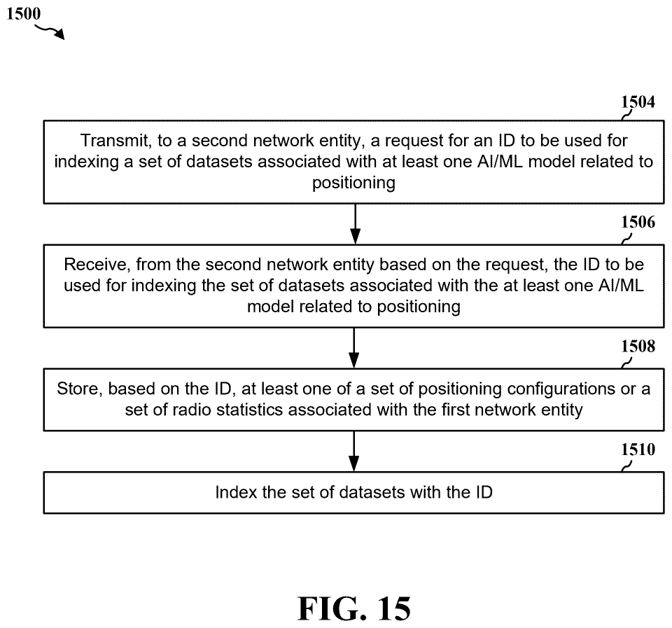

FIG. 15 is a flowchart 1500 of wireless communication. The method may be performed by a first network entity (e.g., the UE 104, 404, 602, 702, 1002, 1402; the apparatus 1604; the base station 102, 706, 1006, 1406; the network entity 1702). The method may enable the first network entity to request an ID for indexing/marking datasets associated with AI/ML model training. Then, multiple network entities may use the ID for AI/ML related positioning training and inference to enable a consistency between the network entities.

At 1504, the first network entity may transmit, to a second network entity, a request for an ID to be used for indexing a set of datasets associated with at least one AI/ML model related to positioning, such as described in connection with FIGS. 10, 11 and 13. For example, as discussed in connection with 1012 of FIG. 10, the UE 1002 may transmit, to a location server 1004 (e.g., a second network entity), a request for an identifier (ID) to be used for indexing the set of datasets associated with the at least one AI/ML model. The transmission of the request may be performed by, e.g., the dataset ID processing component 198, the transceiver(s) 1622, the cellular baseband processor(s) 1624, and/or the application processor(s) 1606 of the apparatus 1604 in FIG. 16. The transmission of the request may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

At 1506, the first network entity may receive, from the second network entity based on the request, the ID to be used for indexing the set of datasets associated with the at least one AI/ML model related to positioning, such as described in connection with FIGS. 10, 11 and 13. For example, as discussed in connection with 1016 of FIG. 10, the UE 1002 may receive, from the location server 1004 based on the request, an ID determined/selected by the location server 1004 for indexing the set of datasets associated with the at least one AI/ML model related to positioning. The reception of the ID may be performed by, e.g., the dataset ID processing component 198, the transceiver(s) 1622, the cellular baseband processor(s) 1624, and/or the application processor(s) 1606 of the apparatus 1604 in FIG. 16. The reception of the ID may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

At 1508, the first network entity may store, based on the ID, at least one of a set of positioning configurations or a set of radio statistics associated with the first network entity, such as described in connection with FIGS. 10, 11 and 13. For example, as discussed in connection with 1018 of FIG. 10, after receiving the ID from the location server 1004 and/or based on the received ID, the UE 1002 may be configured to log (e.g., store) positioning configurations and/or radio characteristics/statistics associated with the UE 1002 (that are related to the dataset collection session) with the ID. The store of the ID may be performed by, e.g., the dataset ID processing component 198, the transceiver(s) 1622, the cellular baseband processor(s) 1624, and/or the application processor(s) 1606 of the apparatus 1604 in FIG. 16. The store of the ID may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

At 1510, the first network entity may index the set of datasets with the ID, such as described in connection with FIGS. 10, 11 and 13. For example, as discussed in connection with 1026 of FIG. 10, the UE 1002 may also index/mark the set of datasets with the ID, such as during or after the dataset collection session. The indexing of the set of datasets may be performed by, e.g., the dataset ID processing component 198, the transceiver(s) 1622, the cellular baseband processor(s) 1624, and/or the application processor(s) 1606 of the apparatus 1604 in FIG. 16. The indexing of the set of datasets may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In one example, the first network entity may initiate dataset indexing for the set of datasets associated with the at least one AI/ML model associated with positioning, where the transmission of the request is based on the initiation of the dataset indexing, such as described in connection with FIGS. 10, 11 and 13. For example, as discussed in connection with 1010 of FIG. 10, the UE 1002 may initiate dataset indexing/marking for the set of datasets associated with the at least one AI/ML model. The initiation of the dataset indexing may be performed by, e.g., the dataset ID processing component 198, the transceiver(s) 1622, the cellular baseband processor(s) 1624, and/or the application processor(s) 1606 of the apparatus 1604 in FIG. 16. The initiation of the dataset indexing may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In another example, the first network entity may train the at least one AI/ML model or a set of positioning functionalities associated with the at least one AI/ML model using the set of datasets indexed with the ID, such as described in connection with FIGS. 10, 11 and 13. For example, as discussed in connection with 1028 of FIG. 10, the UE 1002 may train the at least one AI/ML model (or positioning functionalities associated with the at least one AI/ML model) using the set of datasets indexed with the ID. The training of the at least one AI/ML model or a set of positioning functionalities associated with the at least one AI/ML model may be performed by, e.g., the dataset ID processing component 198, the transceiver(s) 1622, the cellular baseband processor(s) 1624, and/or the application processor(s) 1606 of the apparatus 1604 in FIG. 16. The training of the at least one AI/ML model or a set of positioning functionalities associated with the at least one AI/ML model may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In another example, the first network entity may transmit, to the second network entity, the ID during an AI/ML inference or operation session, and receive, from the second network entity based on the ID, an indication of an AI/ML model to apply for the AI/ML inference or operation session, such as described in connection with FIGS. 10, 11 and 13. For example, as discussed in connection with 1030 of FIG. 10, the UE 1002 may send the ID to the location server 1004. Then, at 1032, based on the positioning configuration(s) and/or radio characteristics/statistics associated with the location server 1004 that are logged/stored with the ID, the location server 1004 may indicate/recommend one or more AI/ML models to the UE 1002 for the AI/ML inference or operation session. The transmission of the ID and/or the reception of the indication may be performed by, e.g., the dataset ID processing component 198, the transceiver(s) 1622, the cellular baseband processor(s) 1624, and/or the application processor(s) 1606 of the apparatus 1604 in FIG. 16. The transmission of the ID and/or the reception of the indication may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17.

In another example, the first network entity may transmit, to the second network entity, an indication of supporting first network entity-side AI/ML positioning that is valid for at least one of positioning configurations or radio statistics, and receive, from the second network entity based on the indication, a second request to apply an LCM for the at least one AI/ML model or for a set of functionalities associated with the at least one AI/ML model, such as described in connection with FIGS. 10 and 13. For example, as discussed in connection with FIG. 10, the UE 1002 may transmit, to the location server 1004, an indication of supporting UE-side AI/ML positioning that is valid for at least one of positioning configurations or radio characteristics/statistics. Based on the indication, the location server 1004 may request the UE 1002 to apply an LCM for at least one AI/ML model or for a set of functionalities associated with the at least one AI/ML model. The transmission of the indication and/or the reception of the second request may be performed by, e.g., the dataset ID processing component 198, the transceiver(s) 1622, the cellular baseband processor(s) 1624, and/or the application processor(s) 1606 of the apparatus 1604 in FIG. 16. The transmission of the indication and/or the reception may also be performed by, e.g., the dataset ID processing component 199, the transceiver(s) 1746, the RU processor(s) 1742, the DU processor(s) 1732, and/or the CU processor(s) 1712, of the network entity 1702 in FIG. 17. In some implementation, the LCM may include at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another example, the first network entity may receive, from the second network entity, an indication of running an AI/ML positioning enabled feature that is valid for at least one of positioning configurations or radio statistics, and modify or adjust, based on the indication, at least one of the set of positioning configurations or the set of radio statistics associated with the first network entity.

In another example, the first network entity may communicate, with the second network entity, an indication to abort using the ID, modifying the ID, or replacing the ID.

In another example, the ID includes at least one of: a unique ID, a cell ID, a RAN area ID, a tracking area ID, a UTC timing plus date, a start/stop timing and date, a landmark fix information, or an expiry time for the ID.

In another example, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another example, the set of radio statistics includes at least one of: an SINR distribution, a set of RSRP measurements, a Rician factor, a delay spread, or a Doppler spread.

In another example, the first network entity is a UE or a base station, and the second network entity is a location server or an LMF.

In another example, to index the set of datasets with the ID, the first network entity may be configured to index the set of datasets with the ID during an active dataset collection session associated with the at least one AI/ML model.

FIG. 16 is a diagram 1600 illustrating an example of a hardware implementation for an apparatus 1604. The apparatus 1604 may be a UE (e.g., a first UE), a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an ultrawide band (UWB) module 1638 (e.g., a UWB transceiver), an SPS module 1616 (e.g., GNSS module), one or more sensors 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the UWB module 1638, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the dataset ID processing component 198 may be configured to transmit, to a second network entity, a request for an ID to be used for indexing a set of datasets associated with at least one AI/ML model related to positioning. The dataset ID processing component 198 may also be configured to receive, from the second network entity based on the request, the ID to be used for indexing the set of datasets associated with the at least one AI/ML model related to positioning. The dataset ID processing component 198 may also be configured to store, based on the ID, at least one of a set of positioning configurations or a set of radio statistics associated with the first network entity. The dataset ID processing component 198 may also be configured to index the set of datasets with the ID. The dataset ID processing component 198 may be within the cellular baseband processor(s) 1624, the application processor(s) 1606, or both the cellular baseband processor(s) 1624 and the application processor(s) 1606. The dataset ID processing component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for transmitting, to a second network entity, a request for an ID to be used for indexing a set of datasets associated with at least one AI/ML model related to positioning. The apparatus 1604 may further include means for receiving, from the second network entity based on the request, the ID to be used for indexing the set of datasets associated with the at least one AI/ML model related to positioning. The apparatus 1604 may further include means for storing, based on the ID, at least one of a set of positioning configurations or a set of radio statistics associated with the first network entity. The apparatus 1604 may further include means for indexing the set of datasets with the ID.

In one configuration, the apparatus 1604 may further include means for initiating dataset indexing for the set of datasets associated with the at least one AI/ML model associated with positioning, where the transmission of the request is based on the initiation of the dataset indexing.

In another configuration, the apparatus 1604 may further include means for training the at least one AI/ML model or a set of positioning functionalities associated with the at least one AI/ML model using the set of datasets indexed with the ID.

In another configuration, the apparatus 1604 may further include means for transmitting, to the second network entity, the ID during an AI/ML inference or operation session, and means for receiving, from the second network entity based on the ID, an indication of an AI/ML model to apply for the AI/ML inference or operation session.

In another configuration, the apparatus 1604 may further include means for transmitting, to the second network entity, an indication of supporting first network entity-side AI/ML positioning that is valid for at least one of positioning configurations or radio statistics, and means for receiving, from the second network entity based on the indication, a second request to apply an LCM for the at least one AI/ML model or for a set of functionalities associated with the at least one AI/ML model. In some implementation, the LCM may include at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another configuration, the apparatus 1604 may further include means for receiving, from the second network entity, an indication of running an AI/ML positioning enabled feature that is valid for at least one of positioning configurations or radio statistics, and means for modifying or means for adjusting, based on the indication, at least one of the set of positioning configurations or the set of radio statistics associated with the first network entity.

In another configuration, the apparatus 1604 may further include means for communicating, with the second network entity, an indication to abort using the ID, modifying the ID, or replacing the ID.

In another configuration, the ID includes at least one of: a unique ID, a cell ID, a RAN area ID, a tracking area ID, a UTC timing plus date, a start/stop timing and date, a landmark fix information, or an expiry time for the ID.

In another configuration, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another configuration, the set of radio statistics includes at least one of: an SINR distribution, a set of RSRP measurements, a Rician factor, a delay spread, or a Doppler spread.

In another configuration, the first network entity is a UE or a base station, and the second network entity is a location server or an LMF.

In another configuration, the means for indexing the set of datasets with the ID may include configuring the apparatus 1604 to index the set of datasets with the ID during an active dataset collection session associated with the at least one AI/ML model.

The means may be the dataset ID processing component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the dataset ID processing component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the dataset ID processing component 199 may be configured to transmit, to a second network entity, a request for an ID to be used for indexing a set of datasets associated with at least one AI/ML model related to positioning. The dataset ID processing component 199 may also be configured to receive, from the second network entity based on the request, the ID to be used for indexing the set of datasets associated with the at least one AI/ML model related to positioning. The dataset ID processing component 199 may also be configured to apply an FEC encoding to the OC block. The dataset ID processing component 199 may also be configured to store, based on the ID, at least one of a set of positioning configurations or a set of radio statistics associated with the first network entity. The dataset ID processing component 199 may also be configured to index the set of datasets with the ID. The dataset ID processing component 199 may be within one or more processors of one or more of the CU 1710, DU 1730, and the RU 1740. The dataset ID processing component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for transmitting, to a second network entity, a request for an ID to be used for indexing a set of datasets associated with at least one AI/ML model related to positioning. The network entity 1702 may further include means for receiving, from the second network entity based on the request, the ID to be used for indexing the set of datasets associated with the at least one AI/ML model related to positioning. The network entity 1702 may further include means for storing, based on the ID, at least one of a set of positioning configurations or a set of radio statistics associated with the first network entity. The network entity 1702 may further include means for indexing the set of datasets with the ID.

In one configuration, the network entity 1702 may further include means for initiating dataset indexing for the set of datasets associated with the at least one AI/ML model associated with positioning, where the transmission of the request is based on the initiation of the dataset indexing.

In another configuration, the network entity 1702 may further include means for training the at least one AI/ML model or a set of positioning functionalities associated with the at least one AI/ML model using the set of datasets indexed with the ID.

In another configuration, the network entity 1702 may further include means for transmitting, to the second network entity, the ID during an AI/ML inference or operation session, and means for receiving, from the second network entity based on the ID, an indication of an AI/ML model to apply for the AI/ML inference or operation session.

In another configuration, the network entity 1702 may further include means for transmitting, to the second network entity, an indication of supporting first network entity-side AI/ML positioning that is valid for at least one of positioning configurations or radio statistics, and means for receiving, from the second network entity based on the indication, a second request to apply an LCM for the at least one AI/ML model or for a set of functionalities associated with the at least one AI/ML model. In some implementation, the LCM may include at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another configuration, the network entity 1702 may further include means for receiving, from the second network entity, an indication of running an AI/ML positioning enabled feature that is valid for at least one of positioning configurations or radio statistics, and means for modifying or means for adjusting, based on the indication, at least one of the set of positioning configurations or the set of radio statistics associated with the first network entity.

In another configuration, the network entity 1702 may further include means for communicating, with the second network entity, an indication to abort using the ID, modifying the ID, or replacing the ID.

In another configuration, the ID includes at least one of: a unique ID, a cell ID, a RAN area ID, a tracking area ID, a UTC timing plus date, a start/stop timing and date, a landmark fix information, or an expiry time for the ID.

In another configuration, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another configuration, the set of radio statistics includes at least one of: an SINR distribution, a set of RSRP measurements, a Rician factor, a delay spread, or a Doppler spread.

In another configuration, the first network entity is a UE or a base station, and the second network entity is a location server or an LMF.

In another configuration, the means for indexing the set of datasets with the ID may include configuring the network entity 1702 to index the set of datasets with the ID during an active dataset collection session associated with the at least one AI/ML model.

The means may be the dataset ID processing component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

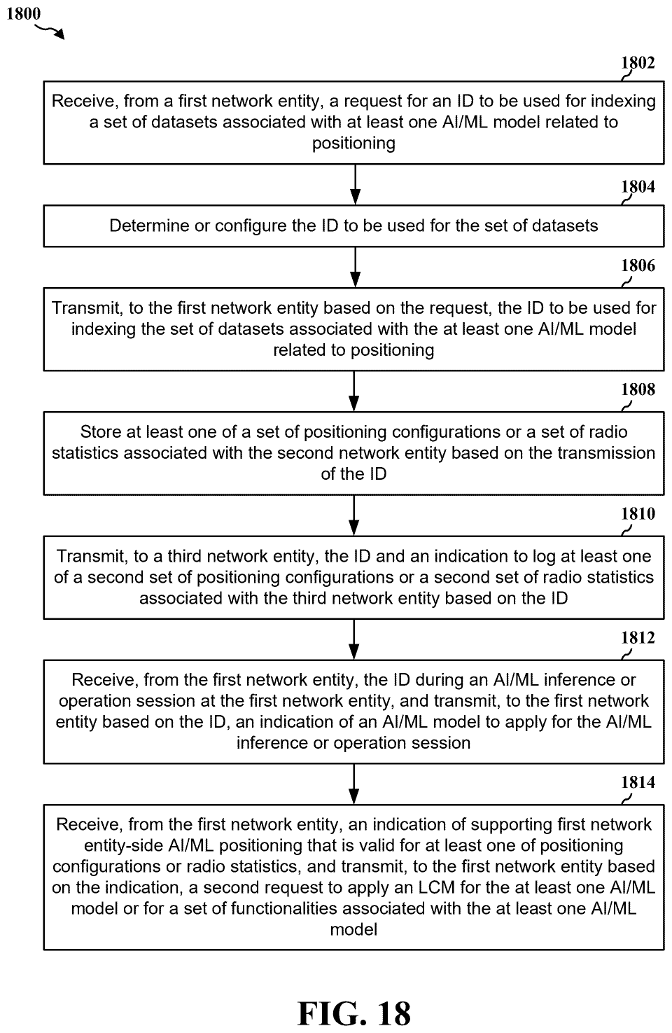

FIG. 18 is a flowchart 1800 of a method of wireless communication. The method may be performed by a second network entity (e.g., the one or more location servers 168; the location server 704, 1004, 1304; network entity 2060). The method may enable the second network entity to select and assign an ID for indexing/marking datasets associated with AI/ML model training to other network entities, such that multiple network entities may use the ID for AI/ML related positioning training and inference to enable a consistency between the network entities.

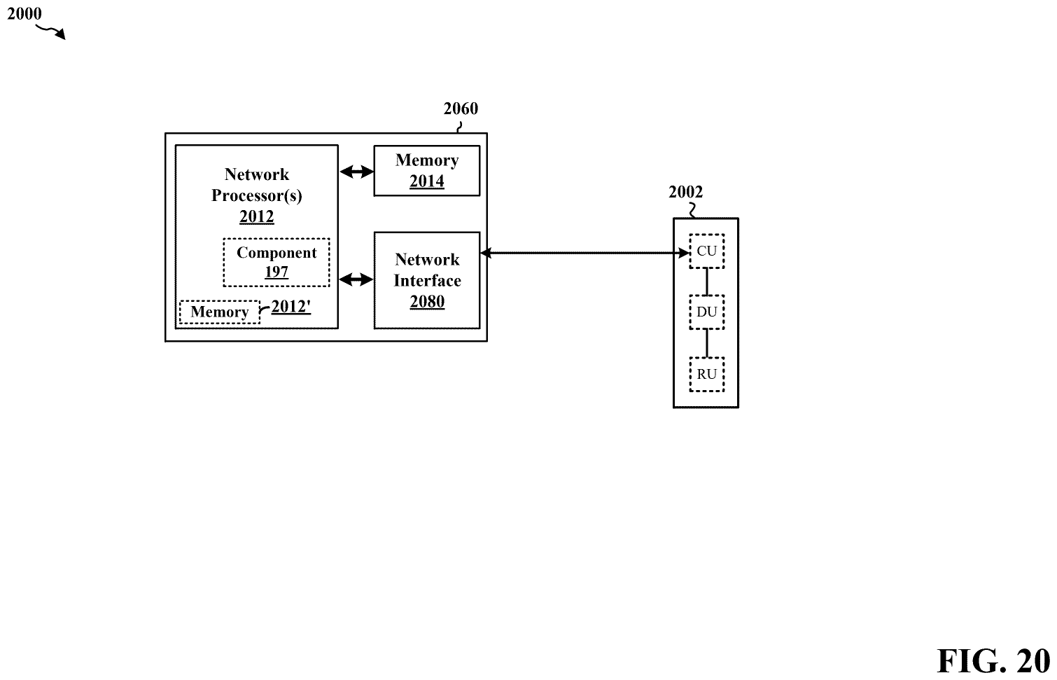

At 1802, the second network entity may receive, from a first network entity, a request for an ID to be used for indexing a set of datasets associated with at least one AI/ML model related to positioning, such as described in connection with FIGS. 10, 11, and 13. For example, as described in connection with 1012 of FIG. 10, the location server 1004 may receive, from the UE 1002, a request for an ID to be used for indexing the set of datasets associated with the at least one AI/ML model. The reception of the request may be performed by, e.g., the dataset ID configuration component 197, the network processor(s) 2012, and/or the network interface 2080 of the network entity 2060 in FIG. 20.

At 1806, the second network entity may transmit, to the first network entity based on the request, the ID to be used for indexing the set of datasets associated with the at least one AI/ML model related to positioning, such as described in connection with FIGS. 10, 11, and 13. For example, as described in connection with 1016 of FIG. 10, the location server 1004 may transmit the determined/selected ID to the UE 1002. The transmission of the ID may be performed by, e.g., the dataset ID configuration component 197, the network processor(s) 2012, and/or the network interface 2080 of the network entity 2060 in FIG. 20.

At 1808, the second network entity may store at least one of a set of positioning configurations or a set of radio statistics associated with the second network entity based on the transmission of the ID, such as described in connection with FIGS. 10, 11, and 13. For example, as described in connection with 1020 of FIG. 10, after selecting/determining the ID or after transmitting the ID to the UE 1002, the location server 1004 may also be configured to log (e.g., store) positioning configurations and/or radio characteristics/statistics associated with the location server 1004 with the ID. The store of the set of positioning configurations or the set of radio statistics may be performed by, e.g., the dataset ID configuration component 197, the network processor(s) 2012, and/or the network interface 2080 of the network entity 2060 in FIG. 20.

In one example, as shown at 1804, the second network entity may determine or configure the ID to be used for the set of datasets, such as described in connection with FIGS. 10, 11, and 13. For example, as described in connection with 1014 of FIG. 10, based on the request from the UE 1002, the location server 1004 may determine/select an ID to be used for the dataset indexing/marking. The determination or configuration of the ID may be performed by, e.g., the dataset ID configuration component 197, the network processor(s) 2012, and/or the network interface 2080 of the network entity 2060 in FIG. 20.

In another example, as shown at 1810, the second network entity may transmit, to a third network entity, the ID and an indication to log at least one of a second set of positioning configurations or a second set of radio statistics associated with the third network entity based on the ID, such as described in connection with FIGS. 10, 11, and 13. For example, as described in connection with 1022 of FIG. 10, the location server 1004 may also transmit/forward the ID to a base station 1006, which may be a serving base station of the UE 1002 or a base station participating in or associated with the positioning session of the UE 1002. The transmission of the ID and the indication may be performed by, e.g., the dataset ID configuration component 197, the network processor(s) 2012, and/or the network interface 2080 of the network entity 2060 in FIG. 20.

In another example, as shown at 1812, the second network entity may receive, from the first network entity, the ID during an AI/ML inference or operation session at the first network entity, and transmit, to the first network entity based on the ID, an indication of an AI/ML model to apply for the AI/ML inference or operation session, such as described in connection with FIGS. 10, 11, and 13. For example, as described in connection with 1030 of FIG. 10, the location server 1004 may receive the ID from the UE 1002 during an AI/ML inference or operation session. Then, at 1032, based on the positioning configuration(s) and/or radio characteristics/statistics associated with the location server 1004 that are logged/stored with the ID, the location server 1004 may indicate/recommend one or more AI/ML models to the UE 1002 for the AI/ML inference or operation session. The reception of the ID and/or the transmission of the indication may be performed by, e.g., the dataset ID configuration component 197, the network processor(s) 2012, and/or the network interface 2080 of the network entity 2060 in FIG. 20.

In another example, as shown at 1814, the second network entity may receive, from the first network entity, an indication of supporting first network entity-side AI/ML positioning that is valid for at least one of positioning configurations or radio statistics, and transmit, to the first network entity based on the indication, a second request to apply an LCM for the at least one AI/ML model or for a set of functionalities associated with the at least one AI/ML model, such as described in connection with FIGS. 10, 11, and 13. For example, as described in connection with FIG. 10, the location server 1004 may receive, from the UE 1002, an indication of supporting UE-side AI/ML positioning that is valid for at least one of positioning configurations or radio characteristics/statistics. Based on the indication, the location server 1004 may request the UE 1002 to apply an LCM for at least one AI/ML model or for a set of functionalities associated with the at least one AI/ML model. The reception of the indication and/or the transmission of the second request may be performed by, e.g., the dataset ID configuration component 197, the network processor(s) 2012, and/or the network interface 2080 of the network entity 2060 in FIG. 20. In some implementations, the LCM includes at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another example, the second network entity may transmit, to the first network entity, an indication of running an AI/ML positioning enabled feature that is valid for at least one of positioning configurations or radio statistics.

In another example, the second network entity may communicate, with the first network entity, an indication to abort using the ID, modifying the ID, or replacing the ID.

In another example, the ID includes at least one of: a unique ID, a cell ID, a RAN area ID, a tracking area ID, a UTC timing plus date, a start/stop timing and date, a landmark fix information, or an expiry time for the ID.

In another example, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another example, the set of radio statistics includes at least one of: an SINR distribution, a set of RSRP measurements, a Rician factor, a delay spread, or a Doppler spread.

In another example, the second network entity is a location server or an LMF, and the first network entity is a UE or a base station.

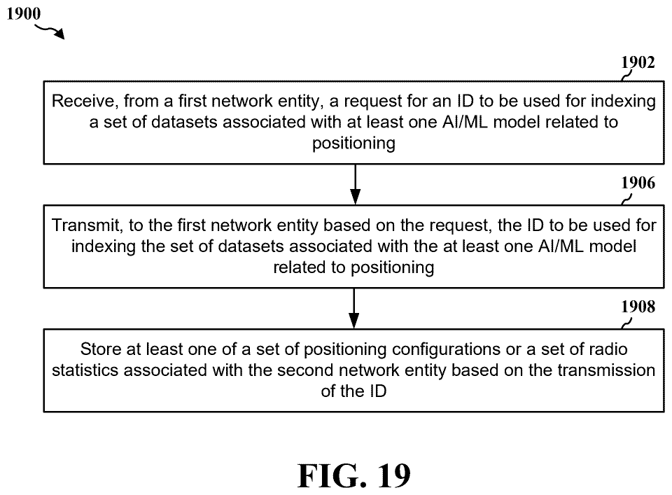

FIG. 19 is a flowchart 1900 of a method of wireless communication. The method may be performed by a second network entity (e.g., the one or more location servers 168; the location server 704, 1004, 1304; network entity 2060). The method may enable the second network entity to select and assign an ID for indexing/marking datasets associated with AI/ML model training to other network entities, such that multiple network entities may use the ID for AI/ML related positioning training and inference to enable a consistency between the network entities.

At 1902, the second network entity may receive, from a first network entity, a request for an ID to be used for indexing a set of datasets associated with at least one AI/ML model related to positioning, such as described in connection with FIGS. 10, 11, and 13. For example, as described in connection with 1012 of FIG. 10, the location server 1004 may receive, from the UE 1002, a request for an ID to be used for indexing the set of datasets associated with the at least one AI/ML model. The reception of the request may be performed by, e.g., the dataset ID configuration component 197, the network processor(s) 2012, and/or the network interface 2080 of the network entity 2060 in FIG. 20.

At 1906, the second network entity may transmit, to the first network entity based on the request, the ID to be used for indexing the set of datasets associated with the at least one AI/ML model related to positioning, such as described in connection with FIGS. 10, 11, and 13. For example, as described in connection with 1016 of FIG. 10, the location server 1004 may transmit the determined/selected ID to the UE 1002. The transmission of the ID may be performed by, e.g., the dataset ID configuration component 197, the network processor(s) 2012, and/or the network interface 2080 of the network entity 2060 in FIG. 20.

At 1908, the second network entity may store at least one of a set of positioning configurations or a set of radio statistics associated with the second network entity based on the transmission of the ID, such as described in connection with FIGS. 10, 11, and 13. For example, as described in connection with 1020 of FIG. 10, after selecting/determining the ID or after transmitting the ID to the UE 1002, the location server 1004 may also be configured to log (e.g., store) positioning configurations and/or radio characteristics/statistics associated with the location server 1004 with the ID. The store of the set of positioning configurations or the set of radio statistics may be performed by, e.g., the dataset ID configuration component 197, the network processor(s) 2012, and/or the network interface 2080 of the network entity 2060 in FIG. 20.

In one example, the second network entity may determine or configure the ID to be used for the set of datasets, such as described in connection with FIGS. 10, 11, and 13. For example, as described in connection with 1014 of FIG. 10, based on the request from the UE 1002, the location server 1004 may determine/select an ID to be used for the dataset indexing/marking. The determination or configuration of the ID may be performed by, e.g., the dataset ID configuration component 197, the network processor(s) 2012, and/or the network interface 2080 of the network entity 2060 in FIG. 20.

In another example, the second network entity may transmit, to a third network entity, the ID and an indication to log at least one of a second set of positioning configurations or a second set of radio statistics associated with the third network entity based on the ID, such as described in connection with FIGS. 10, 11, and 13. For example, as described in connection with 1022 of FIG. 10, the location server 1004 may also transmit/forward the ID to a base station 1006, which may be a serving base station of the UE 1002 or a base station participating in or associated with the positioning session of the UE 1002. The transmission of the ID and the indication may be performed by, e.g., the dataset ID configuration component 197, the network processor(s) 2012, and/or the network interface 2080 of the network entity 2060 in FIG. 20.

In another example, the second network entity may receive, from the first network entity, the ID during an AI/ML inference or operation session at the first network entity, and transmit, to the first network entity based on the ID, an indication of an AI/ML model to apply for the AI/ML inference or operation session, such as described in connection with FIGS. 10, 11, and 13. For example, as described in connection with 1030 of FIG. 10, the location server 1004 may receive the ID from the UE 1002 during an AI/ML inference or operation session. Then, at 1032, based on the positioning configuration(s) and/or radio characteristics/statistics associated with the location server 1004 that are logged/stored with the ID, the location server 1004 may indicate/recommend one or more AI/ML models to the UE 1002 for the AI/ML inference or operation session. The reception of the ID and/or the transmission of the indication may be performed by, e.g., the dataset ID configuration component 197, the network processor(s) 2012, and/or the network interface 2080 of the network entity 2060 in FIG. 20.

In another example, the second network entity may receive, from the first network entity, an indication of supporting first network entity-side AI/ML positioning that is valid for at least one of positioning configurations or radio statistics, and transmit, to the first network entity based on the indication, a second request to apply an LCM for the at least one AI/ML model or for a set of functionalities associated with the at least one AI/ML model, such as described in connection with FIGS. 10, 11, and 13. For example, as described in connection with FIG. 10, the location server 1004 may receive, from the UE 1002, an indication of supporting UE-side AI/ML positioning that is valid for at least one of positioning configurations or radio characteristics/statistics. Based on the indication, the location server 1004 may request the UE 1002 to apply an LCM for at least one AI/ML model or for a set of functionalities associated with the at least one AI/ML model. The reception of the indication and/or the transmission of the second request may be performed by, e.g., the dataset ID configuration component 197, the network processor(s) 2012, and/or the network interface 2080 of the network entity 2060 in FIG. 20. In some implementations, the LCM includes at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another example, the second network entity may transmit, to the first network entity, an indication of running an AI/ML positioning enabled feature that is valid for at least one of positioning configurations or radio statistics.

In another example, the second network entity may communicate, with the first network entity, an indication to abort using the ID, modifying the ID, or replacing the ID.

In another example, the ID includes at least one of: a unique ID, a cell ID, a RAN area ID, a tracking area ID, a UTC timing plus date, a start/stop timing and date, a landmark fix information, or an expiry time for the ID.

In another example, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another example, the set of radio statistics includes at least one of: an SINR distribution, a set of RSRP measurements, a Rician factor, a delay spread, or a Doppler spread.

In another example, the second network entity is a location server or an LMF, and the first network entity is a UE or a base station.

FIG. 20 is a diagram 2000 illustrating an example of a hardware implementation for a network entity 2060. In one example, the network entity 2060 may be within the core network 120. The network entity 2060 may include at least one network processor 2012. The network processor(s) 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The network processor(s) 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the dataset ID configuration component 197 may be configured to receive, from a first network entity, a request for an ID to be used for indexing a set of datasets associated with at least one AI/ML model related to positioning. The dataset ID configuration component 197 may also be configured to transmit, to the first network entity based on the request, the ID to be used for indexing the set of datasets associated with the at least one AI/ML model related to positioning. The dataset ID configuration component 197 may also be configured to store at least one of a set of positioning configurations or a set of radio statistics associated with the second network entity based on the transmission of the ID. The dataset ID configuration component 197 may be within the network processor(s) 2012. The dataset ID configuration component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2060 may include a variety of components configured for various functions. In one configuration, the network entity 2060 may include means for receiving, from a first network entity, a request for an ID to be used for indexing a set of datasets associated with at least one AI/ML model related to positioning. The network entity 2060 may further include means for transmitting, to the first network entity based on the request, the ID to be used for indexing the set of datasets associated with the at least one AI/ML model related to positioning. The network entity 2060 may further include means for storing at least one of a set of positioning configurations or a set of radio statistics associated with the second network entity based on the transmission of the ID.

In one configuration, the network entity 2060 may further include means for determining or mean for configuring the ID to be used for the set of datasets.

In another configuration, the network entity 2060 may further include means for transmitting, to a third network entity, the ID and an indication to log at least one of a second set of positioning configurations or a second set of radio statistics associated with the third network entity based on the ID.

In another configuration, the network entity 2060 may further include means for receiving, from the first network entity, the ID during an AI/ML inference or operation session at the first network entity, and means for transmitting, to the first network entity based on the ID, an indication of an AI/ML model to apply for the AI/ML inference or operation session.

In another configuration, the network entity 2060 may further include means for receiving, from the first network entity, an indication of supporting first network entity-side AI/ML positioning that is valid for at least one of positioning configurations or radio statistics, and means for transmitting, to the first network entity based on the indication, a second request to apply an LCM for the at least one AI/ML model or for a set of functionalities associated with the at least one AI/ML model. In some implementations, the LCM includes at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

In another configuration, the network entity 2060 may further include means for transmitting, to the first network entity, an indication of running an AI/ML positioning enabled feature that is valid for at least one of positioning configurations or radio statistics.

In another configuration, the network entity 2060 may further include means for communicating, with the first network entity, an indication to abort using the ID, modifying the ID, or replacing the ID.

In another configuration, the ID includes at least one of: a unique ID, a cell ID, a RAN area ID, a tracking area ID, a UTC timing plus date, a start/stop timing and date, a landmark fix information, or an expiry time for the ID.

In another configuration, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another configuration, the set of radio statistics includes at least one of: an SINR distribution, a set of RSRP measurements, a Rician factor, a delay spread, or a Doppler spread.

In another configuration, the second network entity is a location server or an LMF, and the first network entity is a UE or a base station.

The means may be the dataset ID configuration component 197 of the network entity 2060 configured to perform the functions recited by the means.

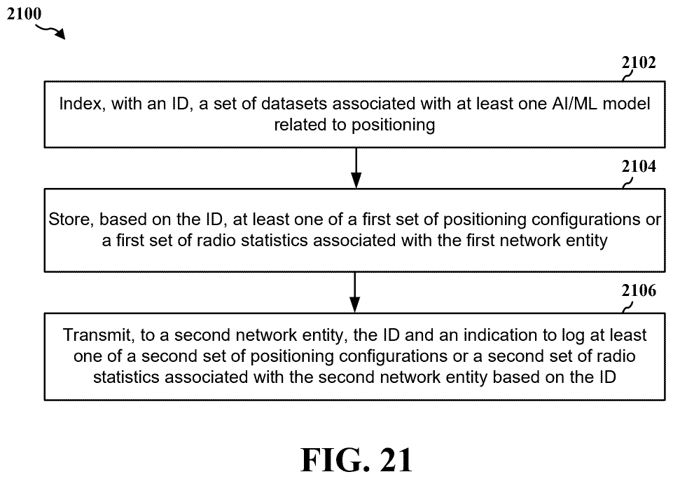

FIG. 21 is a flowchart 2100 of a method of wireless communication. The method may be performed by a first network entity (e.g., the one or more location servers 168; the location server 704, 1204; network entity 2260). The method may enable the second network entity to select and assign an ID for indexing/marking datasets associated with AI/ML model training to other network entities, such that multiple network entities may use the ID for AI/ML related positioning training and inference to enable a consistency between the network entities.

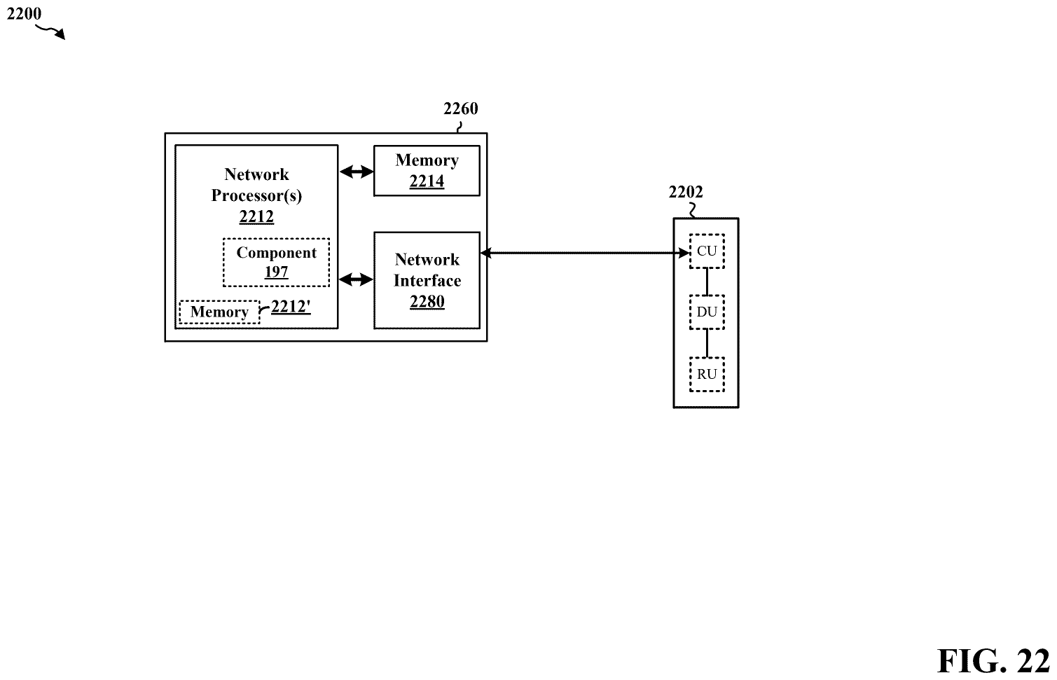

At 2102, the first network entity may index, with an ID, a set of datasets associated with at least one AI/ML model related to positioning, such as described in connection with FIGS. 11 and 12. For example, as described in connection with 1210 of FIG. 12, a location server 1204 (e.g., a first network entity) may initiate dataset indexing/marking for a set of datasets associated with the at least one AI/ML model (e.g., an AI/ML model that is to be used in associated with positioning), and index/mark the set of datasets with an ID. The dataset indexing/marking may be performed during and/or after a dataset collection session. The indexing of the set of datasets may be performed by, e.g., the dataset ID configuration component 197, the network processor(s) 2212, and/or the network interface 2280 of the network entity 2260 in FIG. 22.

At 2104, the first network entity may store, based on the ID, at least one of a first set of positioning configurations or a first set of radio statistics associated with the first network entity, such as described in connection with FIGS. 11 and 12. For example, as described in connection with 1212 of FIG. 12, the location server 1204 may also be configured to log (e.g., store) positioning configurations and/or radio characteristics/statistics associated with the location server 1204 with the ID. The store of the first set of positioning configurations or the first set of radio statistics may be performed by, e.g., the dataset ID configuration component 197, the network processor(s) 2212, and/or the network interface 2280 of the network entity 2260 in FIG. 22.

At 2106, the first network entity may transmit, to a second network entity, the ID and an indication to log at least one of a second set of positioning configurations or a second set of radio statistics associated with the second network entity based on the ID, such as described in connection with FIGS. 11 and 12. For example, as described in connection with 1214 of FIG. 12, after the location server 1204 initiates the dataset indexing and/or indexing/market the set of datasets, the location server 1204 may transmit the ID to a UE 1202 (e.g., a second network entity). In some implementations, the location server 1204 may also transmit, to the UE 1202, an indication to log/store its positioning configurations and/or radio statistics with the ID (or this may be implicit where the UE 1202 is configured to log/store its positioning configurations and/or radio statistics when/after receiving the ID). The transmission of the ID and the indication may be performed by, e.g., the dataset ID configuration component 197, the network processor(s) 2212, and/or the network interface 2280 of the network entity 2260 in FIG. 22.

In one example, the first network entity may train the at least one AI/ML model or a set of positioning functionalities associated with the at least one AI/ML model using the set of datasets indexed with the ID.

In another example, the at least one AI/ML model is an LMF-side AI/ML positioning model.

In one example, the first network entity may communicate, with the second network entity, a second indication to abort using the ID, modifying the ID, or replacing the ID.

In another example, the ID includes at least one of: a unique ID, a cell ID, a RAN area ID, a tracking area ID, a UTC timing plus date, a start/stop timing and date, a landmark fix information, or an expiry time for the ID.

In another example, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another example, the set of radio statistics includes at least one of: an SINR distribution, a set of RSRP measurements, a Rician factor, a delay spread, or a Doppler spread.

In another example, the first entity is a location server or an LMF, and the second entity is a UE or a base station.

FIG. 22 is a diagram 2200 illustrating an example of a hardware implementation for a network entity 2260. In one example, the network entity 2260 may be within the core network 120. The network entity 2260 may include at least one network processor 2212. The network processor(s) 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The on-chip memory 2212′ and the additional memory modules 2214 may each be considered a computer-readable medium/memory. Each computer-readable medium/memory may be non-transitory. The network processor(s) 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the dataset ID configuration component 197 may be configured to index, with an ID, a set of datasets associated with at least one AI/ML model related to positioning. The dataset ID configuration component 197 may also be configured to store, based on the ID, at least one of a first set of positioning configurations or a first set of radio statistics associated with the first network entity. The dataset ID configuration component 197 may also be configured to transmit, to a second network entity, the ID and an indication to log at least one of a second set of positioning configurations or a second set of radio statistics associated with the second network entity based on the ID. The dataset ID configuration component 197 may be within the network processor(s) 2212. The dataset ID configuration component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2260 may include a variety of components configured for various functions. In one configuration, the network entity 2260 may include means for indexing, with an ID, a set of datasets associated with at least one AI/ML model related to positioning. The network entity 2260 may further include means for storing, based on the ID, at least one of a first set of positioning configurations or a first set of radio statistics associated with a second network entity. The network entity 2260 may further include means for transmitting, to a second network entity, the ID and an indication to log at least one of a second set of positioning configurations or a second set of radio statistics associated with the second network entity based on the ID.

In one configuration, the network entity 2260 may further include means for training the at least one AI/ML model or a set of positioning functionalities associated with the at least one AI/ML model using the set of datasets indexed with the ID.

In another configuration, the at least one AI/ML model is an LMF-side AI/ML positioning model.

In one configuration, the network entity 2260 may further include means for communicating, with the second network entity, a second indication to abort using the ID, modifying the ID, or replacing the ID.

In another configuration, the ID includes at least one of: a unique ID, a cell ID, a RAN area ID, a tracking area ID, a UTC timing plus date, a start/stop timing and date, a landmark fix information, or an expiry time for the ID.

In another configuration, the set of positioning configurations includes at least one of: a set of DL PRS beam shapes, a DL PRS antenna pattern, configuration, or down-tilting, a DL PRS TX power, a set of radio unit locations or TRP locations, a mapping of PRS resources to a set of TRP physical locations, an UL SRS TX power, a set of UE SRS beam shapes, or a UE antenna pattern or a set of configurations used for sensing SRS.

In another configuration, the set of radio statistics includes at least one of: an SINR distribution, a set of RSRP measurements, a Rician factor, a delay spread, or a Doppler spread.

In another configuration, the first entity is a location server or an LMF, and the second entity is a UE or a base station.

The means may be the dataset ID configuration component 197 of the network entity 2260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity, comprising: transmitting, to a second network entity, a request for an identifier (ID) to be used for indexing a set of datasets associated with at least one artificial intelligence (AI) or machine learning (ML) (AI/ML) model related to positioning; receiving, from the second network entity based on the request, the ID to be used for indexing the set of datasets associated with the at least one AI/ML model related to positioning; storing, based on the ID, at least one of a set of positioning configurations or a set of radio statistics associated with the first network entity; and indexing the set of datasets with the ID.

Aspect 2 is the method of aspect 1, further comprising: initiating dataset indexing for the set of datasets associated with the at least one AI/ML model associated with positioning, wherein the transmission of the request is based on the initiation of the dataset indexing.

Aspect 3 is the method of aspect 1 or aspect 2, further comprising: training the at least one AI/ML model or a set of positioning functionalities associated with the at least one AI/ML model using the set of datasets indexed with the ID.

Aspect 4 is the method of any of aspects 1 to 3, wherein the at least one AI/ML model is a UE-side AI/ML positioning model or a base station-side AI/ML positioning model.

Aspect 5 is the method of any of aspects 1 to 4, further comprising: transmitting, to the second network entity, the ID during an AI/ML inference or operation session; and receiving, from the second network entity based on the ID, an indication of an AI/ML model to apply for the AI/ML inference or operation session.

Aspect 6 is the method of any of aspects 1 to 5, further comprising: transmitting, to the second network entity, an indication of supporting first network entity-side AI/ML positioning that is valid for at least one of positioning configurations or radio statistics; and receiving, from the second network entity based on the indication, a second request to apply a life cycle management (LCM) for the at least one AI/ML model or for a set of functionalities associated with the at least one AI/ML model.

Aspect 7 is the method of any of aspects 1 to 6, wherein the LCM includes at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

Aspect 8 is the method of any of aspects 1 to 7, further comprising: receiving, from the second network entity, an indication of running an AI/ML positioning enabled feature that is valid for at least one of positioning configurations or radio statistics; and modifying or adjusting, based on the indication, at least one of the set of positioning configurations or the set of radio statistics associated with the first network entity.

Aspect 9 is the method of any of aspects 1 to 8, further comprising: communicating, with the second network entity, an indication to abort using the ID, modifying the ID, or replacing the ID.

Aspect 10 is the method of any of aspects 1 to 9, wherein the ID includes at least one of: a unique ID, a cell ID, a radio access network (RAN) area ID, a tracking area ID, a coordinated universal time (UTC) timing plus date, a start or stop timing and date, a landmark fix information, or an expiry time for the ID.

Aspect 11 is the method of any of aspects 1 to 10, wherein the set of positioning configurations includes at least one of: a set of downlink (DL) positioning reference signal (PRS) beam shapes, a DL PRS antenna pattern, configuration, or down-tilting, a DL PRS transmission (TX) power, a set of radio unit locations or transmission reception point (TRP) locations, a mapping of PRS resources to a set of TRP physical locations, an uplink (UL) sounding reference signal (SRS) TX power, a set of UE SRS beam shapes, or a UE antenna pattern or a set of configurations used for sensing SRS.

Aspect 12 is the method of any of aspects 1 to 11, wherein the set of radio statistics includes at least one of: a signal to interference plus noise ratio (SINR) distribution, a set of reference signal received power (RSRP) measurements, a Rician factor, a delay spread, or a Doppler spread.

Aspect 13 is the method of any of aspects 1 to 12, wherein the first network entity is a user equipment (UE) or a base station, and wherein the second network entity is a location server or a location management function (LMF).

Aspect 14 is the method of any of aspects 1 to 13, wherein indexing the set of datasets with the ID comprises: indexing the set of datasets with the ID during an active dataset collection session associated with the at least one AI/ML model.

Aspect 15 is an apparatus for wireless communication at a first network entity, including: at least one memory; and at least one processor coupled to the at least one memory and, based at least in part on stored information that is stored in the at least one memory, the at least one processor, individually or in any combination, is configured to implement any of aspects 1 to 14.

Aspect 16 is the apparatus of aspect 15, further including at least one transceiver coupled to the at least one processor.

Aspect 17 is an apparatus for wireless communication at a first network entity including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

Aspect 19 is a method of wireless communication at a second network entity, comprising: receiving, from a first network entity, a request for an identifier (ID) to be used for indexing a set of datasets associated with at least one artificial intelligence (AI) or machine learning (ML) (AI/ML) model related to positioning; transmitting, to the first network entity based on the request, the ID to be used for indexing the set of datasets associated with the at least one AI/ML model related to positioning; and storing at least one of a set of positioning configurations or a set of radio statistics associated with the second network entity based on the transmission of the ID.

Aspect 20 is the method of aspect 19, further comprising: determining or configuring the ID to be used for the set of datasets.

Aspect 21 is the method of aspect 19 or aspect 20, further comprising: transmitting, to a third network entity, the ID and an indication to log at least one of a second set of positioning configurations or a second set of radio statistics associated with the third network entity based on the ID.

Aspect 22 is the method of any of aspects 19 to 21, wherein the at least one AI/ML model is a UE-side AI/ML positioning model or a base station-side AI/ML positioning model.

Aspect 23 is the method of any of aspects 19 to 22, further comprising: receiving, from the first network entity, the ID during an AI/ML inference or operation session at the first network entity; and transmitting, to the first network entity based on the ID, an indication of an AI/ML model to apply for the AI/ML inference or operation session.

Aspect 24 is the method of any of aspects 19 to 23, further comprising: receiving, from the first network entity, an indication of supporting first network entity-side AI/ML positioning that is valid for at least one of positioning configurations or radio statistics; and transmitting, to the first network entity based on the indication, a second request to apply a life cycle management (LCM) for the at least one AI/ML model or for a set of functionalities associated with the at least one AI/ML model.

Aspect 25 is the method of any of aspects 19 to 24, wherein the LCM includes at least one of: activating the at least one AI/ML model or the set of functionalities associated with the at least one AI/ML model, deactivating the at least one AI/ML model or the set of functionalities associated with the at least one AI/ML model, selecting an AI/ML model or a functionality in the set of functionalities associated with the at least one AI/ML model, switching to a different AI/ML model, or falling back to a previous AI/ML model or a previous set of functionalities.

Aspect 26 is the method of any of aspects 19 to 25, further comprising: transmitting, to the first network entity, an indication of running an AI/ML positioning enabled feature that is valid for at least one of positioning configurations or radio statistics.

Aspect 27 is the method of any of aspects 19 to 26, further comprising: communicating, with the first network entity, an indication to abort using the ID, modifying the ID, or replacing the ID.

Aspect 28 is the method of any of aspects 19 to 27, wherein the ID includes at least one of: a unique ID, a cell ID, a radio access network (RAN) area ID, a tracking area ID, a coordinated universal time (UTC) timing plus date, a start or stop timing and date, a landmark fix information, or an expiry time for the ID.

Aspect 29 is the method of any of aspects 19 to 28, wherein the set of positioning configurations includes at least one of: a set of downlink (DL) positioning reference signal (PRS) beam shapes, a DL PRS antenna pattern, configuration, or down-tilting, a DL PRS transmission (TX) power, a set of radio unit locations or transmission reception point (TRP) locations, a mapping of PRS resources to a set of TRP physical locations, an uplink (UL) sounding reference signal (SRS) TX power, a set of UE SRS beam shapes, or a UE antenna pattern or a set of configurations used for sensing SRS.

Aspect 30 is the method of any of aspects 19 to 29, wherein the set of radio statistics includes at least one of: a signal to interference plus noise ratio (SINR) distribution, a set of reference signal received power (RSRP) measurements, a Rician factor, a delay spread, or a Doppler spread.

Aspect 31 is the method of any of aspects 19 to 30, wherein the second network entity is a location server or a location management function (LMF), and wherein the first network entity is a user equipment (UE) or a base station.

Aspect 32 is an apparatus for wireless communication at a second network entity, including: at least one memory; and at least one processor coupled to the at least one memory and, based at least in part on stored information that is stored in the at least one memory, the at least one processor, individually or in any combination, is configured to implement any of aspects 19 to 31.

Aspect 33 is the apparatus of aspect 32, further including at least one transceiver coupled to the at least one processor.

Aspect 34 is an apparatus for wireless communication at a second network entity including means for implementing any of aspects 19 to 31.

Aspect 35 is a computer-readable medium (e.g., a non-transitory computer-readable medium) storing computer executable code, where the code when executed by a processor causes the processor to implement any of aspects 19 to 31.

Aspect 36 is a method of wireless communication at a first network entity, comprising: indexing, with an identifier (ID), a set of datasets associated with at least one artificial intelligence (AI) or machine learning (ML) (AI/ML) model related to positioning; storing, based on the ID, at least one of a first set of positioning configurations or a first set of radio statistics associated with a second network entity; and transmitting, to a second network entity, the ID and an indication to log at least one of a second set of positioning configurations or a second set of radio statistics associated with the second network entity based on the ID.

Aspect 37 is the method of aspect 36, further comprising: training the at least one AI/ML model or a set of positioning functionalities associated with the at least one AI/ML model using the set of datasets indexed with the ID.

Aspect 38 is the method of aspect 36 or aspect 37, wherein the at least one AI/ML model is a location management function (LMF)-side AI/ML positioning model.

Aspect 39 is the method of any of aspects 36 to 38, further comprising: communicating, with the second network entity, a second indication to abort using the ID, modifying the ID, or replacing the ID.

Aspect 40 is the method of any of aspects 36 to 39, wherein the ID includes at least one of: a unique ID, a cell ID, a radio access network (RAN) area ID, a tracking area ID, a coordinated universal time (UTC) timing plus date, a start or stop timing and date, a landmark fix information, or an expiry time for the ID.

Aspect 41 is the method of any of aspects 36 to 40, wherein the set of positioning configurations includes at least one of: a set of downlink (DL) positioning reference signal (PRS) beam shapes, a DL PRS antenna pattern, configuration, or down-tilting, a DL PRS transmission (TX) power, a set of radio unit locations or transmission reception point (TRP) locations, a mapping of PRS resources to a set of TRP physical locations, an uplink (UL) sounding reference signal (SRS) TX power, a set of UE SRS beam shapes, or a UE antenna pattern or a set of configurations used for sensing SRS.

Aspect 42 is the method of any of aspects 36 to 41, wherein the set of radio statistics includes at least one of: a signal to interference plus noise ratio (SINR) distribution, a set of reference signal received power (RSRP) measurements, a Rician factor, a delay spread, or a Doppler spread.

Aspect 43 is the method of any of aspects 36 to 42, wherein the first entity is a location server or a location management function (LMF), and wherein the second entity is a user equipment (UE) or a base station.

Aspect 44 is an apparatus for wireless communication at a first network entity, including: at least one memory; and at least one processor coupled to the at least one memory and, based at least in part on stored information that is stored in the at least one memory, the at least one processor, individually or in any combination, is configured to implement any of aspects 36 to 43.

Aspect 45 is the apparatus of aspect 44, further including at least one transceiver coupled to the at least one processor.

Aspect 46 is an apparatus for wireless communication at a first network entity including means for implementing any of aspects 36 to 43.

Aspect 47 is a computer-readable medium (e.g., a non-transitory computer-readable medium) storing computer executable code, where the code when executed by a processor causes the processor to implement any of aspects 36 to 43.

What is claimed is:

1. An apparatus for wireless communication at a first network entity, comprising:
at least one memory; and
at least one processor coupled to the at least one memory, the at least one processor, individually or in any combination, is configured to:
transmit, to a second network entity, a request for an identifier (ID) to be used for indexing a set of datasets associated with at least one artificial intelligence (AI) or machine learning (ML) (AI/ML) model related to positioning;
receive, from the second network entity based on the request, the ID to be used for indexing the set of datasets associated with the at least one AI/ML model related to positioning;
store, based on the ID, at least one of a set of positioning configurations or a set of radio statistics associated with the first network entity; and
index the set of datasets with the ID.

2. The apparatus of claim 1, wherein the at least one processor, individually or in any combination, is further configured to:
initiate dataset indexing for the set of datasets associated with the at least one AI/ML model associated with positioning, wherein the transmission of the request is based on the initiation of the dataset indexing.

3. The apparatus of claim 1, wherein the at least one processor, individually or in any combination, is further configured to:
train the at least one AI/ML model or a set of positioning functionalities associated with the at least one AI/ML model using the set of datasets indexed with the ID.

4. The apparatus of claim 3, wherein the at least one AI/ML model is a UE-side AI/ML positioning model or a base station-side AI/ML positioning model.

5. The apparatus of claim 1, wherein the at least one processor, individually or in any combination, is further configured to:
transmit, to the second network entity, the ID during an AI/ML inference or operation session; and
receive, from the second network entity based on the ID, an indication of an AI/ML model to apply for the AI/ML inference or operation session.

6. The apparatus of claim 1, wherein the at least one processor, individually or in any combination, is further configured to:
transmit, to the second network entity, an indication of supporting first network entity-side AI/ML positioning that is valid for at least one of positioning configurations or radio statistics; and
receive, from the second network entity based on the indication, a second request to apply a life cycle management (LCM) for the at least one AI/ML model or for a set of functionalities associated with the at least one AI/ML model.

7. The apparatus of claim 6, wherein the LCM includes at least one of:
activate the at least one AI/ML model or the set of functionalities associated with the at least one AI/ML model,
deactivate the at least one AI/ML model or the set of functionalities associated with the at least one AI/ML model,
select an AI/ML model or a functionality in the set of functionalities associated with the at least one AI/ML model,
switch to a different AI/ML model, or
fall back to a previous AI/ML model or a previous set of functionalities.

8. The apparatus of claim 1, wherein the at least one processor, individually or in any combination, is further configured to:
receive, from the second network entity, an indication of running an AI/ML positioning enabled feature that is valid for at least one of positioning configurations or radio statistics; and
modify or adjust, based on the indication, at least one of the set of positioning configurations or the set of radio statistics associated with the first network entity.

9. The apparatus of claim 1, further comprising at least one of a transceiver or an antenna coupled to the at least one processor, wherein the at least one processor, individually or in any combination, is further configured to:
communicate, with the second network entity via at least one of the transceiver or the antenna, an indication to abort using the ID, modifying the ID, or replacing the ID.

10. The apparatus of claim 1, wherein the ID includes at least one of:
a unique ID,
a cell ID,
a radio access network (RAN) area ID,
a tracking area ID,
a coordinated universal time (UTC) timing plus date,
a start or stop timing and date,
a landmark fix information, or
an expiry time for the ID.

11. The apparatus of claim 1, wherein the set of positioning configurations includes at least one of:
a set of downlink (DL) positioning reference signal (PRS) beam shapes,
a DL PRS antenna pattern, configuration, or down-tilting,
a DL PRS transmission (TX) power,
a set of radio unit locations or transmission reception point (TRP) locations,
a mapping of PRS resources to a set of TRP physical locations,
an uplink (UL) sounding reference signal (SRS) TX power,
a set of UE SRS beam shapes, or
a UE antenna pattern or a set of configurations used for sensing SRS.

12. The apparatus of claim 1, wherein the set of radio statistics includes at least one of:
a signal to interference plus noise ratio (SINR) distribution,
a set of reference signal received power (RSRP) measurements,
a Rician factor,
a delay spread, or
a Doppler spread.

13. The apparatus of claim 1, wherein the first network entity is a user equipment (UE) or a base station, and wherein the second network entity is a location server or a location management function (LMF).

14. The apparatus of claim 1, wherein to index the set of datasets with the ID, the at least one processor, individually or in any combination, is configured to:
index the set of datasets with the ID during an active dataset collection session associated with the at least one AI/ML model.

15. An apparatus for wireless communication at a second network entity, comprising:
at least one memory; and
at least one processor coupled to the at least one memory, the at least one processor, individually or in any combination, is configured to:
receive, from a first network entity, a request for an identifier (ID) to be used for indexing a set of datasets associated with at least one artificial intelligence (AI) or machine learning (ML) (AI/ML) model related to positioning;
transmit, to the first network entity based on the request, the ID to be used for indexing the set of datasets associated with the at least one AI/ML model related to positioning; and
store at least one of a set of positioning configurations or a set of radio statistics associated with the second network entity based on the transmission of the ID.

16. The apparatus of claim 15, wherein the at least one processor, individually or in any combination, is further configured to:
determine or configure the ID to be used for the set of datasets.

17. The apparatus of claim 15 wherein the at least one processor, individually or in any combination, is further configured to:
transmit, to a third network entity, the ID and an indication to log at least one of a second set of positioning configurations or a second set of radio statistics associated with the third network entity based on the ID.

18. The apparatus of claim 15, wherein the at least one AI/ML model is a UE-side AI/ML positioning model or a base station-side AI/ML positioning model.

19. The apparatus of claim 15, wherein the at least one processor, individually or in any combination, is further configured to:
receive, from the first network entity, the ID during an AI/ML inference or operation session at the first network entity; and
transmit, to the first network entity based on the ID, an indication of an AI/ML model to apply for the AI/ML inference or operation session.

20. An apparatus for wireless communication at a first network entity, comprising:
at least one memory; and
at least one processor coupled to the at least one memory, the at least one processor, individually or in any combination, is configured to:
index, with an identifier (ID), a set of datasets associated with at least one artificial intelligence (AI) or machine learning (ML) (AI/ML) model related to positioning;
store, based on the ID, at least one of a first set of positioning configurations or a first set of radio statistics associated with the first network entity; and
transmit, to a second network entity, the ID and an indication to log at least one of a second set of positioning configurations or a second set of radio statistics associated with the second network entity based on the ID.
